(19) United States
(12) Patent Application Publication
(10) Pub. No.: US 2025/0268309 A1
(43) Pub. Date: Aug. 28, 2025

(54) AEROSOL PROVISION SYSTEM

(71) Applicant: Nicoventures Trading Limited, LONDON (GB)

(72) Inventors: Mike XIAO, London (GB); David LEADLEY, London (GB); Patrick MOLONEY, London (GB)

(21) Appl. No.: 18/245,302

(22) PCT Filed: Sep. 10, 2021
(86) PCT No.: PCT/GB2021/052357

§ 371 Date: Mar. 14, 2023

(30) Foreign Application Priority Data
Sep. 22, 2020 (GB) 2014903.5
Sep. 22, 2020 (GB) 2014909.2
Sep. 22, 2020 (GB) 2014910.0
Sep. 22, 2020 (GB) 2014911.8

(51) Int. Cl. A24F 40/57; A24F 40/42; A24F 40/44; A24F 40/51; A24F 40/60; G01K 7/16; H05B 3/02

(52) U.S. Cl. CPC A24F 40/57; A24F 40/42; A24F 40/44; A24F 40/51; A24F 40/60; G01K 7/16; H05B 3/02

(57) ABSTRACT

An aerosol provision system comprising a reservoir for aerosolisable material; a vaporizer for vaporizing aerosolisable material from the reservoir; and a sensor system, separate from the vaporizer, for detecting the temperature of the vaporizer, wherein the sensor system comprises a first resistor. The sensor system may also comprise a second resistor. Each resistor may be located on a wick from the aerosol provision system, along with the vaporizer. The sensor system may be separate from the vaporizer, in so far as each resistor from the sensor system may be physically spaced from the vaporizer, and in so far as determining the temperature of the vaporizer may be determined off data from the sensor system, as opposed to off any data from the vaporizer itself.

### PRIORITY CLAIM

The present application is a National Phase entry of PCT Application No. PCT/GB2021/052357, filed Sep. 10, 2021, which claims priority from GB Application No. 2014903.5, filed Sep. 22, 2020, GB Application No. 2014909.2, filed Sep. 22, 2020, GB Application No. 2014910.0, filed Sep. 22, 2020 and GB Application No. 2014911.8, filed Sep. 22, 2020, each of which hereby fully incorporated herein by reference.

### FIELD

The present disclosure relates to aerosol provision systems such as nicotine delivery systems (e.g. electronic cigarettes and the like).

### BACKGROUND

Electronic aerosol provision systems such as electronic cigarettes (e-cigarettes) generally contain an aerosol precursor material, such as a reservoir of a source liquid containing a formulation, typically including nicotine, or a solid material such a tobacco-based product, from which an aerosol is generated for inhalation by a user, for example through heat vaporisation. Thus, an aerosol provision system will typically comprise a vaporizer, e.g. a heating element, arranged to vaporize a portion of precursor material to generate an aerosol in an aerosol generation region of an air channel through the aerosol provision system. As a user inhales on the device and electrical power is supplied to the vaporizer, air is drawn into the device through one or more inlet holes and along the air channel to the aerosol generation region, where the air mixes with the vaporized precursor material and forms a condensation aerosol. The air drawn through the aerosol generation region continues along the air channel to a mouthpiece opening, carrying some of the aerosol with it, and out through the mouthpiece opening for inhalation by the user.

It is common for aerosol provision systems to comprise a modular assembly, often having two main functional parts, namely a control unit and disposable/replaceable cartridge part. Typically the cartridge part will comprise the consumable aerosol precursor material and the vaporizer (atomizer), while the control unit part will comprise longer-life items, such as a rechargeable battery, device control circuitry, activation sensors and user interface features. The control unit may also be referred to as a reusable part or battery section and the replaceable cartridge may also be referred to as a disposable part or cartomizer.

The control unit and cartridge are mechanically coupled together at an interface for use, for example using a screw thread, bayonet, latched or friction fit fixing. When the aerosol precursor material in a cartridge has been exhausted, or the user wishes to switch to a different cartridge having a different aerosol precursor material, the cartridge may be removed from the control unit and a replacement cartridge may be attached to the device in its place.

A potential drawbacks for cartridges containing liquid aerosol precursor (e-liquid) is the risk of leakage. An e-cigarette cartridge will typically have a mechanism, e.g. a capillary wick, for drawing aerosolizable material from an aerosolizable material reservoir to a vaporizer located in an air path/channel connecting from an air inlet to an aerosol outlet for the cartridge. Because there is a fluid transport path from the aerosolizable material reservoir into the open air channel through the cartridge, there is a corresponding risk of aerosolizable material leaking from the cartridge. Leakage is undesirable both from the perspective of the end user naturally not wanting to get the e-liquid on their hands or other items, and also from a reliability perspective, since leakage from an end of the cartridge connected to the control unit may damage the control unit, for example due to corrosion. Some approaches to reduce the risk of leakage may involve restricting the flow of aerosolizable material to the vaporizer, for example by tightly clamping a wick where it enters the air channel. In normal use, the aerosolizable material taken up by the wick is sufficient to keep the vaporizer cool (i.e., at an ideal operating temperature), but when the aerosolizable material taken up is insufficient (e.g., when the aerosolizable material in the reservoir runs low) this can in some scenarios give rise to overheating and undesirable flavors.

A further potential drawback in respect of existing aerosol provision systems is the fact that the wick may generate a defect in use, or be initially supplied with such a defect as a result of a fault occurring during the initial manufacturing of the wick. In these instances, such a defect may cause the wick to become excessively hot in use, which is undesirable.

There is also the possibility in such aerosol provision systems that a counterfeit, inferior wick may try to be used in the aerosol provision system, which may have inferior properties making it undesirable for use in the aerosol provision system.

Various approaches are therefore described herein which seek to help address or mitigate some of the issues discussed above.

### SUMMARY

According to a first aspect of certain embodiments there is provided an aerosol provision system comprising:
a reservoir for aerosolizable material;
a vaporizer for vaporising aerosolizable material from the reservoir;
a sensor system, separate from the vaporizer, for detecting the temperature of the vaporizer, wherein the sensor system comprises a first resistor.

According to a second aspect of certain embodiments there is provided a cartridge for an aerosol provision system comprising the cartridge and a control unit, wherein the cartridge comprises:
a reservoir for aerosolizable material;
a vaporizer for vaporising aerosolizable material from the reservoir; and
a sensor system, separate from the vaporizer, for detecting the temperature of the vaporizer, wherein the sensor system comprises a first resistor.

According to a third aspect of certain embodiments there is provided an aerosol provision system comprising:
a reservoir for aerosolizable material;
a vaporizer for vaporising aerosolizable material from the reservoir;
a sensor system, separate from the vaporizer, for determining the temperature of the vaporizer, wherein the sensor system comprises a capacitor and an inductor.

According to a fourth aspect of certain embodiments there is provided a cartridge for an aerosol provision system comprising the cartridge and a control unit, wherein the cartridge comprises:
a reservoir for aerosolizable material;
a vaporizer for vaporising aerosolizable material from the reservoir; and
a sensor system, separate from the vaporizer, for determining the temperature of the vaporizer, wherein the sensor system comprises a capacitor and an inductor.

According to a fifth aspect of certain embodiments there is provided an aerosol provision system comprising:
a reservoir for aerosolizable material;
a wick configured to receive the aerosolizable material from the reservoir;
a vaporizer for vaporising aerosolizable material in the wick; and
control circuitry, wherein the control circuitry is configured to:
   determine a first parameter relating to a temperature of the vaporizer;
   determine a second parameter relating to a temperature of the wick; and
   generate an output signal based on a comparison between the first parameter and the second parameter.

According to a sixth aspect of certain embodiments there is provided a method of monitoring temperatures in an aerosol provision system comprising a reservoir for aerosolizable material, a wick configured to receive the aerosolizable material from the reservoir, and a vaporizer for vaporising aerosolizable material in the wick, wherein the method comprises control circuitry from the aerosol provision system:
determining a first parameter relating to a temperature of the vaporizer;
determining a second parameter relating to a temperature of the wick;
performing a comparison between the first parameter and the second parameter; and
generating an output signal based on the comparison.

According to a seventh aspect of certain embodiments there is provided an aerosol provision system comprising:
a heating element for generating a vapour from an aerosolizable material; and
control circuitry configured to provide power for the heating element for performing a heating operation to generate the vapour, and configured for use in detecting a fault condition, wherein the control circuitry is configured to:
establish a first resistance value for the resistance of the heating element at a first predetermined time during the heating operation; and
establish a second resistance value for the heating element at a second predetermined time, after the first predetermined time, during the heating operation;
compare the second resistance value with an expected resistance value, wherein the expected resistance value is higher than, and based on, the first resistance value; and
detect a fault condition in the event the second resistance value exceeds the expected resistance value by a predetermined amount, wherein the predetermined amount decreases as the first resistance value increases.

According to an eighth aspect of certain embodiments there is provided an aerosol provision system comprising:
a heating element for generating a vapour from an aerosolizable material; and
control circuitry configured to provide power for the heating element for performing a heating operation to generate the vapour, and configured for use in detecting a fault condition, wherein the control circuitry is configured to:
establish a first resistance value for the resistance of the heating element at a first predetermined time during the heating operation;
establish the time taken, from the first predetermined time, for the heating element to reach a predetermined resistance value during the heating operation, wherein the predetermined resistance value is larger than the first resistance value;
compare the time taken with an expected time taken, wherein the expected time taken is based on the first resistance value; and
detect a fault condition in the event the time taken is less than the expected time taken by at least a predetermined amount, wherein the predetermined amount decreases as the first resistance value increases.

According to a ninth aspect of certain embodiments there is provided a method of detecting a fault condition in an aerosol provision system, wherein the aerosol provision system further comprises control circuitry, and wherein the method comprises the control circuitry:
providing power to a heating element for performing a heating operation to generate vapour from an aerosolizable material;
establishing a first resistance value for the resistance of the heating element at a first predetermined time during the heating operation;
establishing a second resistance value for the heating element at a second predetermined time, after the first predetermined time, during the heating operation;
comparing the second resistance value with an expected resistance value, wherein the expected resistance value is higher than, and based on, the first resistance value; and
detecting a fault condition in the event the second resistance value exceeds the expected resistance value by a predetermined amount, wherein the predetermined amount decreases as the first resistance value increases.

According to a tenth aspect of certain embodiments there is provided a method of detecting a fault condition in an aerosol provision system, wherein the aerosol provision system further comprises control circuitry, and wherein the method comprises the control circuitry:
providing power to a heating element for performing a heating operation to generate vapour from an aerosolizable material;
establishing a first resistance value for the resistance of the heating element at a first predetermined time during the heating operation; and
establishing the time taken, from the first predetermined time, for the heating element to reach a predetermined resistance value during the heating operation, wherein the predetermined resistance value is larger than the first resistance value;
comparing the time taken with an expected time taken, wherein the expected time taken is based on the first resistance value; and
detecting a fault condition in the event the time taken is less than the expected time taken by at least a predetermined amount, wherein the predetermined amount decreases as the first resistance value increases.

It will be appreciated that features and aspects of the invention described above in relation to the various aspects of the invention are equally applicable to, and may be combined with, embodiments of the invention according to other aspects of the invention as appropriate, and not just in the specific combinations described herein.

### BRIEF DESCRIPTION OF THE DRAWINGS

Embodiments of the invention will now be described, by way of example only, with reference to the accompanying drawings, in which:

FIG. 1 schematically represents in perspective view an aerosol provision system comprising a cartridge and control unit (shown separated) in accordance with certain embodiments of the disclosure;

FIG. 2 schematically represents in exploded perspective view of components of the cartridge of the aerosol provision system of FIG. 1;

FIGS. 3A to 3C schematically represent various cross-section views of a housing part of the cartridge of the aerosol provision system of FIG. 1;

FIGS. 4A and 4B schematically represent a perspective view and a plan view of a dividing wall element of the cartridge of the aerosol provision system of FIG. 1;

FIGS. 5A to 5C schematically represent two perspective views and a plan view of a resilient plug of the cartridge of the aerosol provision system of FIG. 1;

FIGS. 6A and 6B schematically represent a perspective view and a plan view of a bottom cap of the cartridge of the aerosol provision system of FIG. 1;

FIG. 7A represents a schematic view of an aerosol provision system in accordance with certain embodiments of the disclosure, and which employs a sensor system in accordance with certain embodiments of the disclosure provided herein;

FIG. 7B represents a schematic view of a portion of the disclosure from FIG. 7A, and which illustrates further aspects of an embodiment of sensor system in accordance with certain embodiments of the disclosure provided herein;

FIG. 8 represents a schematic view of an aerosol provision system in accordance with certain embodiments of the disclosure, and which employs a sensor system in accordance with certain embodiments of the disclosure provided herein; and

FIG. 9 represents a schematic view of an aerosol provision system in accordance with certain embodiments of the disclosure, and which employs a sensor system in accordance with certain embodiments of the disclosure provided herein.

FIG. 10A represents a schematic view of an aerosol provision system in accordance with certain embodiments of the disclosure, and which employs a sensor system in accordance with certain embodiments of the disclosure provided herein;

FIG. 10B represents a schematic view of an embodiment of sensor system in accordance with certain embodiments of the disclosure provided herein, and which is useable with the aerosol provision systems described herein;

FIG. 10C represents a schematic view of an embodiment of sensor system in accordance with certain embodiments of the disclosure provided herein, and which is useable with the aerosol provision systems described herein;

FIG. 11 represents a schematic view of an aerosol provision system in accordance with certain embodiments of the disclosure, and which employs a sensor system in accordance with certain embodiments of the disclosure provided herein;

FIG. 12 represents a schematic view of an aerosol provision system in accordance with certain embodiments of the disclosure, and which employs a sensor system in accordance with certain embodiments of the disclosure provided herein;

FIG. 13 represents a plot of temperatures which may be exhibited in an aerosol provision system, such as that shown in FIG. 1, during use;

FIG. 14 represents a schematic view of an aerosol provision system in accordance with certain embodiments of the disclosure;

FIG. 15A represents a schematic chart illustrating the resistance of a heating element from an aerosol provision system changing over time and during a heating operation, and which relates to embodiments of the present disclosure;

FIG. 15B represents a similar chart to that of FIG. 15A, whereby the heating element is subjected to a heating operation shortly after a previous heating operation has been completed, and which relates to embodiments of the present disclosure;

FIG. 16A represents a schematic chart illustrating the resistance of a heating element from an aerosol provision system changing over time and during a heating operation, and which relates to embodiments of the present disclosure; and

FIG. 16B represents a similar chart to that of FIG. 16A, whereby the heating element is subjected to a heating operation shortly after a previous heating operation has been completed, and which relates to embodiments of the present disclosure.

### DETAILED DESCRIPTION

Aspects and features of certain examples and embodiments are discussed/described herein. Some aspects and features of certain examples and embodiments may be implemented conventionally and these are not discussed/described in detail in the interests of brevity. It will thus be appreciated that aspects and features of apparatus and methods discussed herein which are not described in detail may be implemented in accordance with any conventional techniques for implementing such aspects and features.

The present disclosure relates to non-combustible aerosol provision systems, which may also be referred to as aerosol provision systems, such as e-cigarettes. According to the present disclosure, a “non-combustible” aerosol provision system is one where a constituent aerosolizable material of the aerosol provision system (or component thereof) is not combusted or burned in order to facilitate delivery to a user. Aerosolizable material, which also may be referred to herein as aerosol generating material or aerosol precursor material, is material that is capable of generating aerosol, for example when heated, irradiated or energized in any other way.

Throughout the following description the term “e-cigarette” or “electronic cigarette” may sometimes be used, but it will be appreciated this term may be used interchangeably with aerosol provision system/device and electronic aerosol provision system/device. An electronic cigarette may also known as a vaping device or electronic nicotine delivery system (END), although it is noted that the presence of nicotine in the aerosolizable material is not a requirement.

In some embodiments, the non-combustible aerosol provision system is a hybrid system to generate aerosol using a combination of aerosolizable materials, one or a plurality of which may be heated. In some embodiments, the hybrid system comprises a liquid or gel aerosolizable material and a solid aerosolizable material. The solid aerosolizable material may comprise, for example, tobacco or a non-tobacco product.

Typically, the non-combustible aerosol provision system may comprise a non-combustible aerosol provision device and an article for use with the non-combustible aerosol provision device. However, it is envisaged that articles which themselves comprise a means for powering an aerosol generating component may themselves form the non-combustible aerosol provision system.

In some embodiments, the article for use with the non-combustible aerosol provision device may comprise an aerosolizable material (or aerosol precursor material), an aerosol generating component (or vaporizer), an aerosol generating area, a mouthpiece, and/or an area for receiving aerosolizable material.

In some embodiments, the aerosol generating component is a heater capable of interacting with the aerosolizable material so as to release one or more volatiles from the aerosolizable material to form an aerosol. In some embodiments, the aerosol generating component is capable of generating an aerosol from the aerosolizable material without heating. For example, the aerosol generating component may be capable of generating an aerosol from the aerosolizable material without applying heat thereto, for example via one or more of vibrational, mechanical, pressurisation or electrostatic means.

In some embodiments, the substance to be delivered may be an aerosolizable material which may comprise an active constituent, a carrier constituent and optionally one or more other functional constituents.

The active constituent may comprise one or more physiologically and/or olfactory active constituents which are included in the aerosolizable material in order to achieve a physiological and/or olfactory response in the user. The active constituent may for example be selected from nutraceuticals, nootropics, and psychoactives. The active constituent may be naturally occurring or synthetically obtained. The active constituent may comprise for example nicotine, caffeine, taurine, theine, a vitamin such as B6 or B12 or C, melatonin, a cannabinoid, or a constituent, derivative, or combinations thereof. The active constituent may comprise a constituent, derivative or extract of tobacco or of another botanical. In some embodiments, the active constituent is a physiologically active constituent and may be selected from nicotine, nicotine salts (e.g. nicotine ditartrate/nicotine bitartrate), nicotine-free tobacco substitutes, other alkaloids such as caffeine, or mixtures thereof.

In some embodiments, the active constituent is an olfactory active constituent and may be selected from a “flavor” and/or “flavorant” which, where local regulations permit, may be used to create a desired taste, aroma or other somatosensorial sensation in a product for adult consumers. In some instances such constituents may be referred to as flavors, flavorants, cooling agents, heating agents, and/or sweetening agents. They may include naturally occurring flavor materials, botanicals, extracts of botanicals, synthetically obtained materials, or combinations thereof (e.g., tobacco, cannabis, licorice (liquorice), hydrangea, eugenol, Japanese white bark magnolia leaf, chamomile, fenugreek, clove, maple, matcha, menthol, Japanese mint, aniseed (anise), cinnamon, turmeric, Indian spices, Asian spices, herb, wintergreen, cherry, berry, red berry, cranberry, peach, apple, orange, mango, clementine, lemon, lime, tropical fruit, papaya, rhubarb, grape, durian, dragon fruit, cucumber, blueberry, mulberry, citrus fruits, Drambuie, bourbon, scotch, whiskey, gin, tequila, rum, spearmint, peppermint, lavender, aloe vera, cardamom, celery, cascarilla, nutmeg, sandalwood, bergamot, geranium, khat, naswar, betel, shisha, pine, honey essence, rose oil, vanilla, lemon oil, orange oil, orange blossom, cherry blossom, cassia, caraway, cognac, jasmine, ylang-ylang, sage, fennel, wasabi, piment, ginger, coriander, coffee, hemp, a mint oil from any species of the genus Mentha, eucalyptus, star anise, cocoa, lemongrass, rooibos, flax, Ginkgo biloba, hazel, hibiscus, laurel, mate, orange skin, rose, tea such as green tea or black tea, thyme, juniper, elderflower, basil, bay leaves, cumin, oregano, paprika, rosemary, saffron, lemon peel, mint, beefsteak plant, curcuma, cilantro, myrtle, cassis, valerian, pimento, mace, damien, marjoram, olive, lemon balm, lemon basil, chive, carvi, verbena, tarragon, limonene, thymol, camphene), flavor enhancers, bitterness receptor site blockers, sensorial receptor site activators or stimulators, sugars and/or sugar substitutes (e.g., sucralose, acesulfame potassium, aspartame, saccharine, cyclamates, lactose, sucrose, glucose, fructose, sorbitol, or mannitol), and other additives such as charcoal, chlorophyll, minerals, botanicals, or breath freshening agents. They may be imitation, synthetic or natural ingredients or blends thereof. They may be in any suitable form, for example, liquid such as an oil, solid such as a powder, or gasone or more of extracts (e.g., licorice, hydrangea, Japanese white bark magnolia leaf, chamomile, fenugreek, clove, menthol, Japanese mint, aniseed, cinnamon, herb, wintergreen, cherry, berry, peach, apple, Drambuie, bourbon, scotch, whiskey, spearmint, peppermint, lavender, cardamom, celery, cascarilla, nutmeg, sandalwood, bergamot, geranium, honey essence, rose oil, vanilla, lemon oil, orange oil, cassia, caraway, cognac, jasmine, ylang-ylang, sage, fennel, piment, ginger, anise, coriander, coffee, or a mint oil from any species of the genus Mentha), flavor enhancers, bitterness receptor site blockers, sensorial receptor site activators or stimulators, sugars and/or sugar substitutes (e.g., sucralose, acesulfame potassium, aspartame, saccharine, cyclamates, lactose, sucrose, glucose, fructose, sorbitol, or mannitol), and other additives such as charcoal, chlorophyll, minerals, botanicals, or breath freshening agents. They may be imitation, synthetic or natural ingredients or blends thereof. They may be in any suitable form, for example, oil, liquid, or powder.

In some embodiments, the flavor comprises menthol, spearmint and/or peppermint. In some embodiments, the flavor comprises flavor components of cucumber, blueberry, citrus fruits and/or redberry. In some embodiments, the flavor comprises eugenol. In some embodiments, the flavor comprises flavor components extracted from tobacco. In some embodiments, the flavor may comprise a sensate, which is intended to achieve a somatosensorial sensation which are usually chemically induced and perceived by the stimulation of the fifth cranial nerve (trigeminal nerve), in addition to or in place of aroma or taste nerves, and these may include agents providing heating, cooling, tingling, numbing effect. A suitable heat effect agent may be, but is not limited to, vanillyl ethyl ether and a suitable cooling agent may be, but not limited to eucalyptol, WS-3.

The carrier constituent may comprise one or more constituents capable of forming an aerosol. In some embodiments, the carrier constituent may comprise one or more of glycerine, glycerol, propylene glycol, diethylene glycol, triethylene glycol, tetraethylene glycol, 1,3-butylene glycol, erythritol, meso-Erythritol, ethyl vanillate, ethyl laurate, a diethyl suberate, triethyl citrate, triacetin, a diacetin mixture, benzyl benzoate, benzyl phenyl acetate, tributyrin, lauryl acetate, lauric acid, myristic acid, and propylene carbonate.

The one or more other functional constituents may comprise one or more of pH regulators, colouring agents, preservatives, binders, fillers, stabilizers, and/or antioxidants.

As noted above, aerosol provision systems (e-cigarettes) often comprise a modular assembly including both a reusable part (control unit) and a replaceable (disposable) cartridge part. Devices conforming to this type of two-part modular configuration may generally be referred to as two-part devices. It is also common for electronic cigarettes to have a generally elongate shape. For the sake of providing a concrete example, certain embodiments of the disclosure described herein comprise this kind of generally elongate two-part device employing disposable cartridges. However, it will be appreciated the underlying principles described herein may equally be adopted for other electronic cigarette configurations, for example modular devices comprising more than two parts, as devices conforming to other overall shapes, for example based on so-called box-mod high performance devices that typically have a more boxy shape.

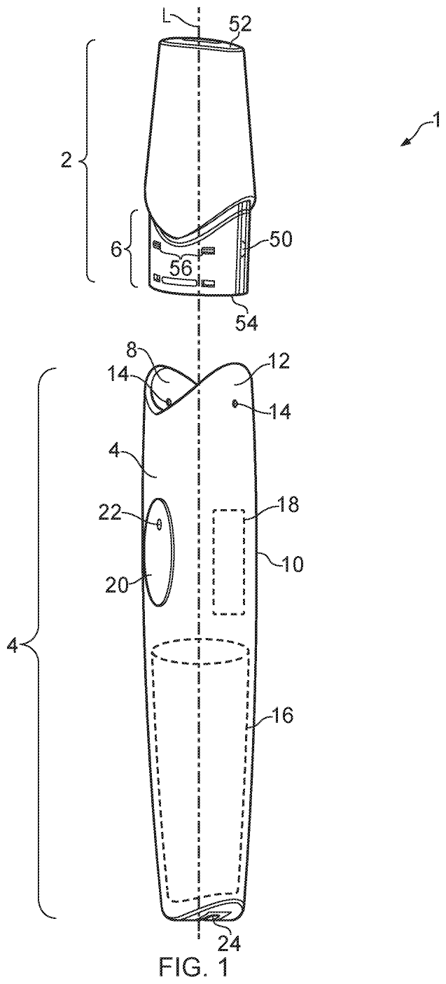

FIG. 1 is a schematic perspective view of an example aerosol provision system/device (e-cigarette) 1 in accordance with certain embodiments of the disclosure. Terms concerning the relative location of various aspects of the electronic cigarette (e.g. terms such as upper, lower, above, below, top, bottom etc.) are used herein with reference to the orientation of the electronic cigarette as shown in FIG. 1 (unless the context indicates otherwise). However, it will be appreciated this is purely for ease of explanation and is not intended to indicate there is any required orientation for the electronic cigarette in use.

The e-cigarette 1 comprises two main components, namely a cartridge 2 and a control unit 4. The control unit 4 and the cartridge 2 are shown separated in FIG. 1, but are coupled together when in use.

The cartridge 2 and control unit 4 are coupled by establishing a mechanical and electrical connection between them. The specific manner in which the mechanical and electrical connection is established is not of primary significance to the principles described herein and may be established in accordance with conventional techniques, for example based around a screw thread, bayonet, latched or friction-fit mechanical fixing with appropriately arranged electrical contacts/electrodes for establishing the electrical connection between the two parts as appropriate. For example electronic cigarette 1 represented in FIG. 1, the cartridge comprises a mouthpiece end 52 and an interface end 54 and is coupled to the control unit by inserting an interface end portion 6 at the interface end of the cartridge into a corresponding receptacle 8/cartridge receiving section of the control unit. The interface end portion 6 of the cartridge is a close fit to be receptacle 8 and includes protrusions 56 which engage with corresponding detents in the interior surface of a receptacle wall 12 defining the receptacle 8 to provide a releasable mechanical engagement between the cartridge and the control unit. An electrical connection is established between the control unit and the cartridge via a pair of electrical contacts on the bottom of the cartridge (not shown in FIG. 1) and corresponding sprung contact pins in the base of the receptacle 8 (not shown in FIG. 1). As noted above, the specific manner in which the electrical connection is established is not significant to the principles described herein, and indeed some implementations might not have an electrical connection between the cartridge and a control unit at all, for example because the transfer of electrical power from the reusable part to the cartridge may be wireless (e.g. based on electromagnetic induction techniques).

The electronic cigarette 1 has a generally elongate shape extending along a longitudinal axis L. When the cartridge is coupled to the control unit, the overall length of the electronic cigarette in this example (along the longitudinal axis) is around 12.5 cm. The overall length of the control unit is around 9 cm and the overall length of the cartridge is around 5 cm (i.e. there is around 1.5 cm of overlap between the interface end portion 6 of the cartridge and the receptacle 8 of the control unit when they are coupled together). The electronic cigarette has a cross-section which is generally oval and which is largest around the middle of the electronic cigarette and tapers in a curved manner towards the ends. The cross-section around the middle of the electronic cigarette has a width of around 2.5 cm and a thickness of around 1.7 cm. The end of the cartridge has a width of around 2 cm and a thickness of around 0.6 mm, whereas the other end of the electronic cigarette has a width of around 2 cm and a thickness of around 1.2 cm. The outer housing of the electronic cigarette is in this example is formed from plastic. It will be appreciated the specific size and shape of the electronic cigarette and the material from which it is made is not of primary significance to the principles described herein and may be different in different implementations. That is to say, the principles described herein may equally be adopted for electronic cigarettes having different sizes, shapes and/or materials.

The control unit 4 may in accordance with certain embodiments of the disclosure be broadly conventional in terms of its functionality and general construction techniques. In the example of FIG. 1, the control unit 4 comprises a plastic outer housing 10 including the receptacle wall 12 that defines the receptacle 8 for receiving the end of the cartridge as noted above. The outer housing 10 of the control unit 4 in this example has a generally oval cross section conforming to the shape and size of the cartridge 2 at their interface to provide a smooth transition between the two parts. The receptacle 8 and the end portion 6 of the cartridge 2 are symmetric when rotated through 180° so the cartridge can be inserted into the control unit in two different orientations. The receptacle wall 12 includes two control unit air inlet openings 14 (i.e. holes in the wall). These openings 14 are positioned to align with an air inlet 50 for the cartridge when the cartridge is coupled to the control unit. A different one of the openings 14 aligns with the air inlet 50 of the cartridge in the different orientations. It will be appreciated some implementations may not have any degree of rotational symmetry such that the cartridge is couplable to the control unit in only one orientation while other implementations may have a higher degree of rotational symmetry such that the cartridge is couplable to the control unit in more orientations.

The control unit further comprises a battery 16 for providing operating power for the electronic cigarette, control circuitry 18 for controlling and monitoring the operation of the electronic cigarette, a user input button 20, an indicator light 22, and a charging port 24.

The battery 16 in this example is rechargeable and may be of a conventional type, for example of the kind normally used in electronic cigarettes and other applications requiring provision of relatively high currents over relatively short periods. The battery 16 may be recharged through the charging port 24, which may, for example, comprise a USB connector.

The input button 20 in this example is a conventional mechanical button, for example comprising a sprung mounted component which may be pressed by a user to establish an electrical contact in underlying circuitry. In this regard, the input button may be considered an input device for detecting user input, e.g. to trigger aerosol generation, and the specific manner in which the button is implemented is not significant. For example, other forms of mechanical button or touch-sensitive button (e.g. based on capacitive or optical sensing techniques) may be used in other implementations, or there may be no button and the device may rely on a puff detector for triggering aerosol generation.

The indicator light 22 is provided to give a user with a visual indication of various characteristics associated with the electronic cigarette, for example, an indication of an operating state (e.g. on/off/standby), and other characteristics, such as battery life or fault conditions. Different characteristics may, for example, be indicated through different colours and/or different flash sequences in accordance with generally conventional techniques.

The control circuitry 18 is suitably configured/programmed to control the operation of the electronic cigarette to provide conventional operating functions in line with the established techniques for controlling electronic cigarettes. The control circuitry (processor circuitry) 18 may be considered to logically comprise various sub-units/circuitry elements associated with different aspects of the electronic cigarette's operation. For example, depending on the functionality provided in different implementations, the control circuitry 18 may comprises power supply control circuitry for controlling the supply of power from the battery/power supply to the cartridge in response to user input, user programming circuitry for establishing configuration settings (e.g. user-defined power settings) in response to user input, as well as other functional units/circuitry associated functionality in accordance with the principles described herein and conventional operating aspects of electronic cigarettes, such as indicator light display driving circuitry and user input detection circuitry. It will be appreciated the functionality of the control circuitry 18 can be provided in various different ways, for example using one or more suitably programmed programmable computer(s) and/or one or more suitably configured application-specific integrated circuit(s)/circuitry/chip(s)/chipset(s) configured to provide the desired functionality.

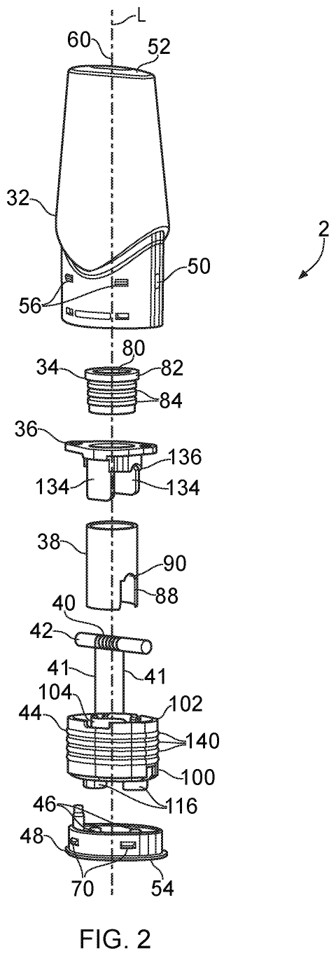

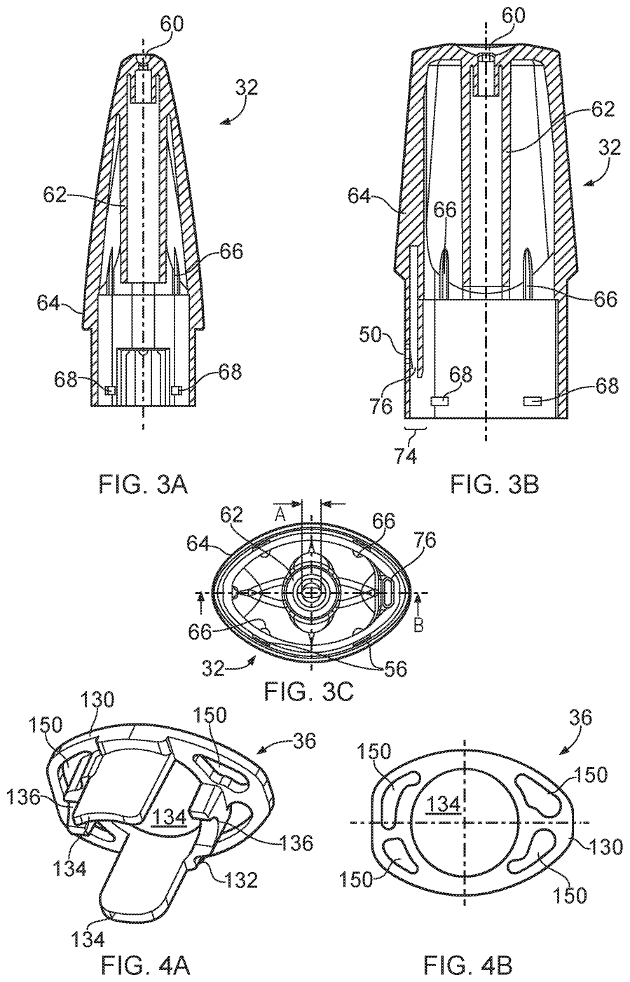

FIG. 2 is an exploded schematic perspective view of the cartridge 2 (exploded along the longitudinal axis L). The cartridge 2 comprises a housing part 32, an air channel seal 34, a dividing wall element 36, an outlet tube 38, a vaporizer/heating element 40, an aerosolizable material transport element/wick 42, a plug 44, and an end cap 48 with contact electrodes 46. FIGS. 3 to 6 schematically represents some of these components in more detail.

FIG. 3A is a schematic cut-away view of the housing part 32 through the longitudinal axis L where the housing part 32 is thinnest. FIG. 3B is a schematic cut-away view of the housing part 32 through the longitudinal axis L where the housing part 32 is widest. FIG. 3C is a schematic view of the housing part along the longitudinal axis L from the interface end 54 (i.e. viewed from below in the orientation of FIGS. 3A and 3B).

FIG. 4A is a schematic perspective view of the dividing wall element 36 as seen from below. FIG. 4B is a schematic cross-section through an upper part of the dividing wall element 36 as viewed from below.

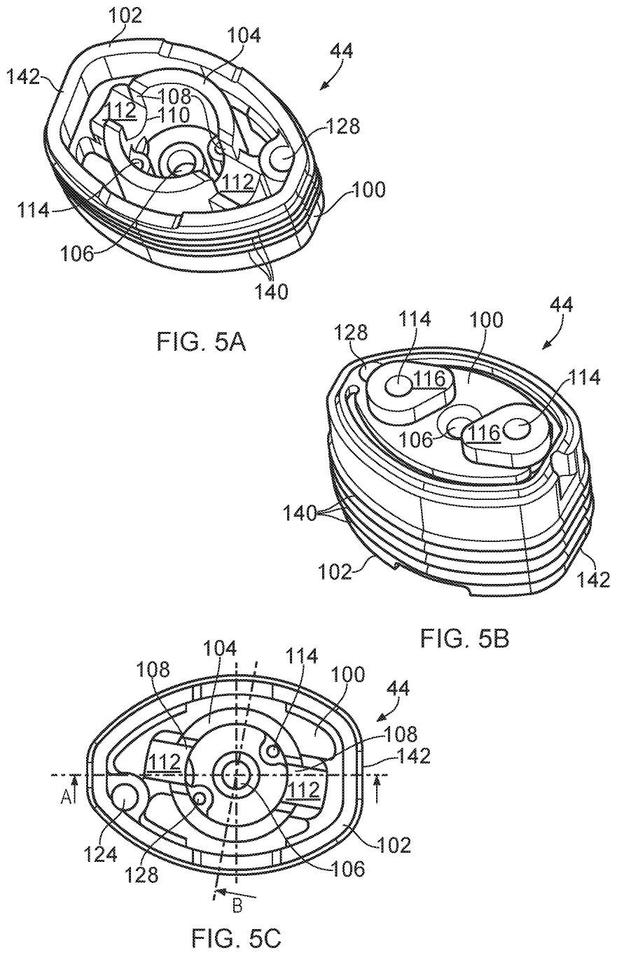

FIG. 5A is a schematic perspective view of the plug 44 from above and FIG. 5B is a schematic perspective view of the plug 44 from below. FIG. 5C is a schematic view of the plug 44 along the longitudinal axis L seen from the mouthpiece end 52 of the cartridge (i.e. viewed from above for the orientation in FIGS. 1 and 2).

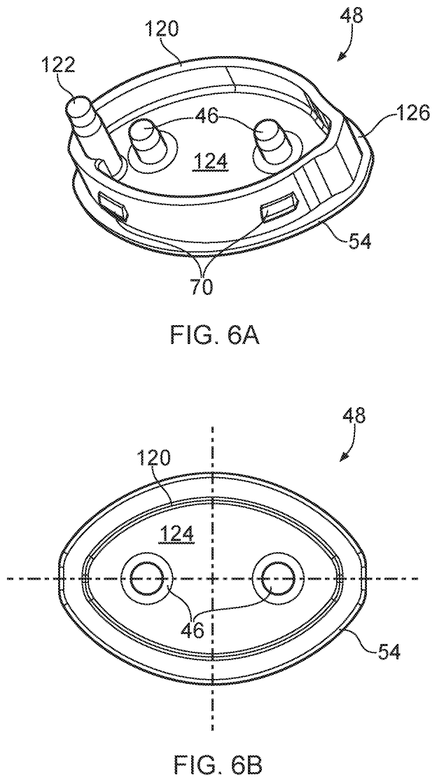

FIG. 6A is a schematic perspective view of the end cap 48 from above. FIG. 6B is a schematic view of the end cap 48 along the longitudinal axis L seen from the mouthpiece end 52 of the cartridge (i.e. from above).

The housing part 32 in this example comprises a housing outer wall 64 and a housing inner tube 62 which in this example are formed from a single moulding of polypropylene. The housing outer wall 64 defines the external appearance of the cartridge 2 and the housing inner tube 62 defines a part the air channel through the cartridge. The housing part is open at the interface end 54 of the cartridge and closed at the mouthpiece end 52 of the cartridge except for a mouthpiece opening/aerosol outlet 60 in fluid communication with the housing inner tube 62. The housing part 32 includes an opening in a sidewall which provides the air inlet 50 for the cartridge. The air inlet 50 in this example has an area of around 2 mm². The outer surface of the outer wall 64 of the housing part 32 includes the protrusions 56 discussed above which engage with corresponding detents in the interior surface of the receptacle wall 12 defining the receptacle 8 to provide a releasable mechanical engagement between the cartridge and the control unit. The inner surface of the outer wall 64 of the housing part includes further protrusions 66 which act to provide an abutment stop for locating the dividing wall element 36 along the longitudinal axis L when the cartridge is assembled. The outer wall 64 of the housing part 32 further comprises holes which provide latch recesses 68 arranged to receive corresponding latch projections 70 in the end cap to fix the end cap to be housing part when the cartridge is assembled.

The outer wall 64 of the housing part 32 includes a double-walled section 74 that defines a gap 76 in fluid communication with the air inlet 50. The gap 76 provides a portion of the air channel through the cartridge. In this example the doubled-walled section 74 of the housing part 32 is arranged so the gap defines an air channel running within the housing outer wall 64 parallel to the longitudinal axis with a cross-section in a plane perpendicular to the longitudinal axis of around 3 mm². The gap/portion of air channel 76 defined by the double-walled section of the housing part extends down to the open end of the housing part 32.

The air channel seal 34 is a silicone moulding generally in the form of a tube having a through hole 80. The outer wall of the air channel seal 34 includes circumferential ridges 84 and an upper collar 82. The inner wall of the air channel seal 34 also includes circumferential ridges, but these are not visible in FIG. 2. When the cartridge is assembled the air channel seal 34 is mounted to the housing inner tube 62 with an end of the housing inner tube 62 extending partly into the through hole 80 of the air channel seal 34. The through hole 80 in the air channel seal has a diameter of around 5.8 mm in its relaxed state whereas the end of the housing inner tube 62 has a diameter of around 6.2 mm so that a seal is formed when the air channel seal 34 is stretched to accommodate the housing inner tube 62. This seal is facilitated by the ridges on the inner surface of the air channel seal 34.

The outlet tube 38 comprises a tubular section of ANSI 304 stainless steel with an internal diameter of around 8.6 mm and a wall thickness of around 0.2 mm. The bottom end of the outlet tube 38 includes a pair of diametrically opposing slots 88 with an end of each slot having a semi-circular recess 90. When the cartridge is assembled the outlet tube 38 mounts to the outer surface of the air channel seal 34. The outer diameter of the air channel seal is around 9.0 mm in its relaxed state so that a seal is formed when the air channel seal 34 is compressed to fit inside the outlet tube 38. This seal is facilitated by the ridges 84 on the outer surface of the air channel seal 34. The collar 80 on the air channel seal 34 provides a stop for the outlet tube 38.

The aerosolizable material transport element 42 comprises a capillary wick and the vaporizer 40 comprises a resistance wire heater wound around the capillary wick. In addition to the portion of the resistance wire wound around the capillary wick, the vaporizer comprises electrical leads 41 which pass through holes in the plug 44 to contact electrodes 46 mounted to the end cap 54 to allow power to be supplied to the vaporizer via the electrical interface the established when the cartridge is connected to a control unit. The vaporizer leads 41 may comprise the same material as the resistance wire wound around the capillary wick, or may comprise a different material (e.g. lower-resistance material) connected to the resistance wire wound around the capillary wick. In this example the heater coil 40 comprises a nickel iron alloy wire and the wick 42 comprises a glass fibre bundle. The vaporizer and aerosolizable material transport element (wick) may be provided in accordance with any conventional techniques and is may comprise different forms and/or different materials. For example, in some implementations the wick may comprise fibrous or solid a ceramic material and the heater may comprise a different alloy. In other examples the heater and wick may be combined, for example in the form of a porous and a resistive material. More generally, it will be appreciated the specific nature aerosolizable material transport element and vaporizer is not of primary significance to the principles described herein.

When the cartridge is assembled, the wick 42 is received in the semi-circular recesses 90 of the outlet tube 38 so that a central portion of the wick about which the heating coil is would is inside the outlet tube while end portions of the wick are outside the outlet tube 38.

The plug 44 in this example comprises a single moulding of silicone, may be resilient. The plug comprises a base part 100 with an outer wall 102 extending upwardly therefrom (i.e. towards the mouthpiece end of the cartridge). The plug further comprises an inner wall 104 extending upwardly from the base part 100 and surrounding a through hole 106 through the base part 100.

The outer wall 102 of the plug 44 conforms to an inner surface of the housing part 32 so that when the cartridge is assembled the plug in 44 forms a seal with the housing part 32. The inner wall 104 of the plug 44 conforms to an inner surface of the outlet tube 38 so that when the cartridge is assembled the plug 44 also forms a seal with the outlet tube 38. The inner wall 104 includes a pair of diametrically opposing slots 108 with the end of each slot having a semi-circular recess 110. Extended outwardly (i.e. in a direction away from the longitudinal axis of the cartridge) from the bottom of each slot in the inner wall 104 is a cradle section 112 shaped to receive a section of the aerosolizable material transport element 42 when the cartridge is assembled. The slots 108 and semi-circular recesses 110 provided by the inner wall of the plug 44 and the slots 88 and semi-circular recesses 90 of the outlet tube 38 are aligned so that the slots 88 in the outlet tube 38 accommodate respective ones of the cradles 112 with the respective semi-circular recesses in the outlet tube and plug cooperating to define holes through which the aerosolizable material transport element passes. The size of the holes provided by the semi-circular recesses through which the aerosolizable material transport element passes correspond closely to the size and shape of the aerosolizable material transport element, but are slightly smaller so a degree of compression is provided by the resilience of the plug 44. This allows aerosolizable material to be transported along the aerosolizable material transport element (wick) by capillary action while restricting the extent to which aerosolizable material which is not transported by capillary action can pass through the openings. As noted above, the plug 44 includes further openings 114 in the base part 100 through which the contact leads 41 for the vaporizer pass when the cartridge is assembled. The bottom of the base part of the plug includes spacers 116 which maintain an offset between the remaining surface of the bottom of the base part and the end cap 48. These spacers 116 include the openings 114 through which the electrical contact leads 41 for the vaporizer pass.

The end cap 48 comprises a polypropylene moulding with a pair of gold-plated copper electrode posts 46 mounted therein.

The ends of the electrode posts 44 on the bottom side of the end cap are close to flush with the interface end 54 of the cartridge provided by the end cap 48. These are the parts of the electrodes to which correspondingly aligned sprung contacts in the control unit connect when the cartridge is assembled and connected to the control unit. The ends of the electrode posts on the inside of the cartridge extend away from the end cap 48 and into the holes 114 in the plug 44 through which the contact leads 41 pass. The electrode posts are slightly oversized relative to the holes 114 and include a chamfer at their upper ends to facilitate insertion into the holes 114 in the plug where they are maintained in pressed contact with the contact leads for the vaporizer by virtue of the plug.

The end cap has a base section 124 and an upstanding wall 120 which conforms to the inner surface of the housing part 32. The upstanding wall 120 of the end cap 48 is inserted into the housing part 32 so the latch projections 70 engage with the latch recesses 68 in the housing part 32 to snap-fit the end cap 48 to the housing part when the cartridge is assembled. The top of the upstanding wall 120 of the end cap 48 abuts a peripheral part of the plug 44 and the lower face of the spacers 116 on the plug also abut the base section 124 of the plug so that when the end cap 48 is attached to the housing part it presses against the resilient part 44 to maintain it in slight compression.

The base portion 124 of the end cap 48 includes a peripheral lip 126 beyond the base of the upstanding wall 112 with a thickness which corresponds with the thickness of the outer wall of the housing part at the interface end of the cartridge. The end cap also includes an upstanding locating pin 122 which aligns with a corresponding locating hole 128 in the plug to help establish their relative location during assembly.

The dividing wall element 36 comprises a single moulding of polypropylene and includes a dividing wall 130 and a collar 132 formed by projections from the dividing wall 130 in the direction towards the interface end of the cartridge. The dividing wall element 36 has a central opening 134 through which the outlet tube 38 passes (i.e. the dividing wall is arranged around the outlet tube 38). When the cartridge is assembled, the upper surface of the outer wall 102 of the plug 44 engages with the lower surface of the dividing wall 130, and the upper surface of the dividing wall 130 in turn engages with the projections 66 on the inner surface of the outer wall 64 of the housing part 32. Thus, the dividing wall 130 prevents the plug from being pushed too far into the housing part 32—i.e. the dividing wall 130 is fixedly located along the longitudinal axis of the cartridge by the protrusions 66 in the housing part and so provides the plug with a fixed surface to push against. The collar 132 formed by projections from the dividing wall includes a first pair of opposing projections/tongues 134 which engage with corresponding recesses on an inner surface of the outer wall 102 of the plug 44. The protrusions from the dividing wall 130 further provide a pair of cradle sections 136 configured to engage with corresponding ones of the cradle sections 112 in the part 44 when the cartridge is assembled to further define the opening through which the aerosolizable material transport element passes.

When the cartridge is assembled an air channel extending from the air inlet 50 to the aerosol outlet 60 through the cartridge is formed. Starting from the air inlet 50 in the side wall of the housing part 32, a first section of the air channel is provided by the gap 76 formed by the double-walled section 74 in the outer wall 64 of the housing part 32 and extends from the air inlet 50 towards the interface end 54 of the cartridge and past the plug 44. A second portion of the air channel is provided by the gap between the base of the plug 44 and the end cap 48. A third portion of the air channel is provided by the hole 106 through the plug 44. A fourth portion of the air channel is provided by the region within the inner wall 104 of the plug and the outlet tube around the vaporizer 40. This fourth portion of the air channel may also be referred to as an aerosol/aerosol generation region, it being the primary region in which aerosol is generated during use. The air channel from the air inlet 50 to the aerosol generation region may be referred to as an air inlet section of the air channel. A fifth portion of the air channel is provided by the remainder of the outlet tube 38. A sixth portion of the air channel is provided by the outer housing inner tube 62 which connects the air channel to the aerosol outlet 60. The air channel from the aerosol generation region to be the aerosol outlet may be referred to as an aerosol outlet section of the air channel.

Also, when the cartridge is assembled a reservoir 31 for aerosolizable material is formed by the space outside the air channel and inside the housing part 32. This may be filled during manufacture, for example through a filling hole which is then sealed, or by other means. The specific nature of the aerosolizable material, for example in terms of its composition, is not of primary significance to the principles described herein, and in general any conventional aerosolizable material of the type normally used in electronic cigarettes may be used. The present disclosure may refer to a liquid as the aerosolizable material, which as mentioned above may be a conventional e-liquid. However, the principles of the present disclosure apply to any aerosolizable material which has the ability to flow, and may include a liquid, a gel, or a solid, where for a solid a plurality of solid particles may be considered to have the ability to flow when considered as a bulk.

The reservoir is closed at the interface end of the cartridge by the plug 44. The reservoir includes a first region above the dividing wall 130 and a second region below the dividing wall 130 within the space formed between the air channel and the outer wall of the plug. The aerosolizable material transport element (capillary wick) 42 passes through openings in the wall of the air channel provided by the semi-circular recesses 108, 90 in the plug 44 and the outlet tube 38 and the cradle sections 112, 136 in the plug 44 and the dividing wall element 36 that engage with one another as discussed above. Thus, the ends of the aerosolizable material transport element extend into the second region of the reservoir from which they draw aerosolizable material through the openings in the air channel to the vaporizer 40 for subsequent vaporisation.

In normal use, the cartridge 2 is coupled to the control unit 4 and the control unit activated to supply power to the cartridge via the contact electrodes 46 in the end cap 48. Power then passes through the connection leads 41 to the vaporizer 40. The vaporizer is thus electrically heated and so vaporizes a portion of the aerosolizable material from the aerosolizable material transport element in the vicinity of the vaporizer. This generates aerosol in the aerosol generation region of the air path. Aerosolizable material that is vaporized from the aerosolizable material transport element is replaced by more aerosolizable material drawn from the reservoir by capillary action. While the vaporizer is activated, a user inhales on the mouthpiece end 52 of the cartridge. This causes air to be drawn through whichever control unit air inlet 14 aligns with the air inlet 50 of the cartridge (which will depend on the orientation in which the cartridge was inserted into the control unit receptacle 8). Air then enters the cartridge through the air inlet 50, passes along the gap 76 in the double-walled section 74 of the housing part 32, passes between the plug 44 and the end cap 48 before entering the aerosol generation region surrounding the vaporizer 40 through the hole 106 in the base part 100 of the plug 44. The incoming air mixes with aerosol generated from the vaporizer to form a condensation aerosol, which is then drawn along the outlet tube 38 and the housing part inner 62 before exiting through the mouthpiece outlet/aerosol outlet 60 for user inhalation.

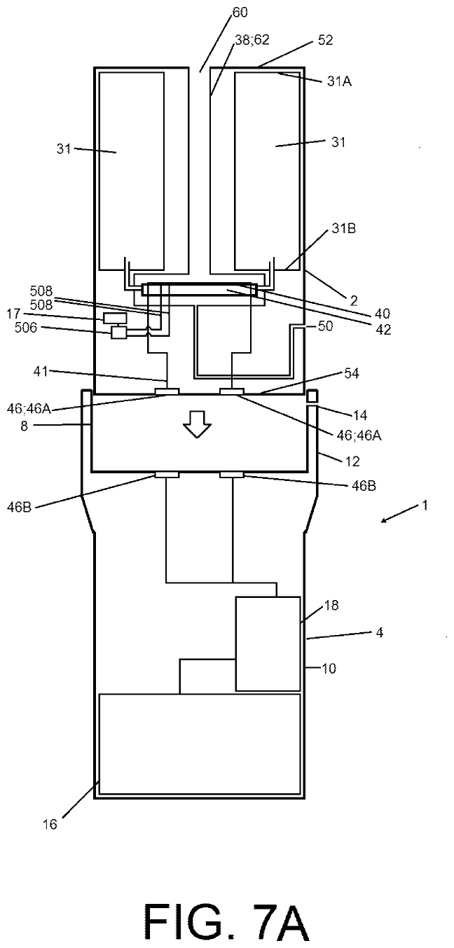

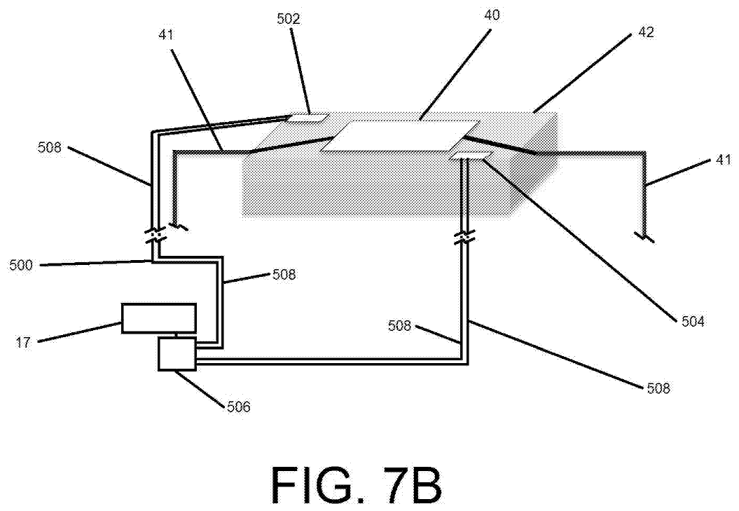

With reference to FIG. 7A, there is shown schematically a cross section view of a modified version of the aerosol provision system 1, including the cartridge 2 and the control unit 4. The aerosol provision system 1; cartridge 2; and control unit 4 shown in FIG. 7A are based on the construction of the corresponding aerosol provision system 1; cartridge 2; and control unit 4; shown in FIGS. 1-6B, and comprise similar components as set out by the reference numerals that are common to both sets of Figures. For instance, the cartridge 2 from FIG. 7A defines a reservoir 31 which extends around an aerosol outlet tube 38. In accordance with such embodiments, the reservoir 31 may be annular, and is configured for containing aerosolizable material for aerosolising. Similarly, the control unit 4 from FIG. 7A may comprise the plastic outer housing 10 including the receptacle wall 12 that defines the receptacle 8 for receiving the end of the cartridge 2. The control unit 4 from FIG. 7A may also comprise the control circuitry 18 and the power supply/battery 16. In such embodiments, the cartridge 2 may comprise a first contact electrode(s) 46; 46A for engaging with a second contact electrode(s) 46; 46B from the interface from the control unit 4 for transferring power between the control circuitry 18 in the control unit 4 and the vaporizer 40 in the cartridge 2.

In accordance with some embodiments, such as this embodiment shown in FIG. 7A, the reservoir 31 may comprise a first end 31A which is proximal the aerosol outlet 60 of the cartridge 2, and a second end 31B which is proximal the vaporizer 40.

Relating to FIG. 7A is FIG. 7B which shows a schematic view of the region of the vaporizer 40 from FIG. 7A, and which also illustrates an embodiment of sensor system 500 which may be introduced into any of the aerosol provision systems 1 described herein. As will be described, the sensor system 500 is for detecting the temperature of the vaporizer 40.

In the above respect therefore, FIGS. 7A and 7B illustrate an embodiment of aerosol provision system 1 which comprises, in a broad sense, a reservoir 31 for aerosolizable material; a vaporizer 40 for vaporising aerosolizable material from the reservoir 31; and a sensor system 500, separate from the vaporizer 40, for detecting the temperature of the vaporizer 40, wherein the sensor system 500 comprises a first resistor 502 . . . . As indicated in the embodiment shown in FIG. 7B, the sensor system 500 is notionally separate from the vaporizer 40, in so far as any resistor(s) 502 from the sensor system may be physically spaced from the vaporizer 40, and in so far as determining the temperature of the vaporizer 40 may be determined off data from the sensor system 500, as opposed to off any data from the vaporizer 40 itself, as will be described.

In the above respect, there currently exists sensor arrangements which determine the temperature of the vaporizer 40 by monitoring the resistance value of the vaporizer 40 itself. From this resistance value of the vaporizer, the sensor arrangement can then determine the temperature of the vaporizer 40, noting the resistance of the vaporizer 40 is directly related to the temperature of the vaporizer 40. Whilst such arrangements are entirely workable in practice, these sensor arrangements notionally rely on the higher power circuitry which is also used to power the vaporizer 40.

Conscious of the above, the sensor system 500 as described herein is contrastingly separate from the vaporizer 40, in so far as any resistor(s) from the sensor system may be physically spaced from the vaporizer 40, and in so far as determining the temperature of the vaporizer 40 may be determined off data from the sensor system 500.

With the above in mind, and starting with the first resistor 502 (as illustrated in the embodiment of FIG. 7B), the first resistor 502 in accordance with some embodiments may be provided in a location proximate to the vaporizer 40. From this location, the sensor system 500 may be configured to determine the temperature of the vaporizer 40 based on a recorded measurement from the first resistor 502. In a particularly convenient embodiment, the recorded measurement may be a voltage drop across the first resistor 502. In that respect, on the basis the sensor system 500 may be configured to provide a predetermined amount of power to the first resistor 502, the voltage drop across the first resistor 502 will be related to its recorded resistance, which in itself will be affected by the temperature of the first resistor 502. Accordingly, by measuring the voltage drop across the first resistor 502, this can be used to determine the current temperature of the first resistor 502.

Following the above further, it will be appreciated that the temperature of the first resistor 502 will be directly related to the temperature of the vaporizer 40. In that respect, the exact relationship between the temperature of the vaporizer 40 and the first resistor 502 will be dependent on the separation between the two components. For the sake of completeness, the temperature of the first resistor 502 may increase as the first resistor 502 is positioned closer to the (heated) vaporizer 40. Accordingly, for a given aerosol provision system 1, and based of a predetermined known separation between the first resistor 502 and the vaporizer 40, the sensor system 500 can be configured to be determine any temperature of the vaporizer 40 based off a measurement from (e.g. a voltage drop across) the first resistor 502.

In accordance with some embodiments, and to further improve the accuracy of the sensor system 500 to be able to determine the temperature of the vaporizer 40, in accordance with some embodiments, the sensor system 500 may comprise a second resistor 504, as illustrated in FIG. 7B. Where such a second resistor 504 is provided, like the first resistor 502, the sensor system 500 may be configured to determine the temperature of the vaporizer 40 based on a recorded measurement from the second resistor 504. In a particularly convenient embodiment, the recorded measurement may be a voltage drop across the second resistor 504. In that respect, on the basis the sensor system 500 may be configured to provide a predetermined amount of power to the second resistor 504, the voltage drop across the second resistor 504 will be related to its resistance, which in itself will be affected by the temperature of the second resistor 504, and thus ultimately the temperature of the vaporizer 40 as explained above in respect of the first resistor 502.

Where such a second resistor 504 is provided, it may be located the same distance away from the vaporizer 40 as the first resistor 502 is spaced from the vaporizer 40, or may be located a different distance away from the vaporizer 40 as the first resistor 502 is spaced from the vaporizer 40. By spacing the first resistor 502 and the second resistor 504 at different amounts away from the vaporizer 40 (e.g. the first resistor 502 being located closer to the vaporizer 40 than the second resistor 504 is located to the vaporizer 40), this may facilitate the sensor system 500 to be able to more accurately determine the temperature of the vaporizer 40, since the recorded measurement/voltage drop across the second resistor 504 and the first resistor 502 will provide two different variables of recorded measurement/voltage drop, which can be more easily/reliably mapped back to a particular temperature of the vaporizer 40, compared with when just one resistor 502 and thus one variable of recorded measurement/voltage drop is present from which to determine the temperature of the vaporizer 40.

A further advantage of providing the second resistor 504 is to generate an additional fail-safe in the sensor system 500, in so far as if one of the first and/or second resistors 502;504 fails, the remaining first resistor 502 or second resistor 504 is still able to notionally function to allow the sensor system to determine/detect the temperature of the vaporizer 40.

Where such a second resistor 504 is provided, the sensor system 500 may in some embodiments be separately connected to each of the first resistor 502 and the second resistor 504, as shown in the embodiment of FIG. 7B. In accordance with other embodiments, the first resistor 502 may be connected in parallel with the second resistor 504, or the first resistor 502 may be connected in series with the second resistor 504. In such a series type arrangement, in accordance with some particular embodiments the first resistor 502 and the second resistor 504 may form a potential divider, wherein the sensor system 500 is configured to measure a voltage drop across the first resistor 502. In this particular embodiment, and where the first resistor 502 and the second resistor 504 are located at different amounts away from the vaporizer 40, the voltage drop across the first resistor 502 may be indicative of a particular temperature of the vaporizer 40, such that the sensor system 500 in some particular embodiments thereof may be configured to process the value of the voltage drop across the first resistor 502 to detect/determine the temperature of the vaporizer 40. In such arrangements, it will equally be appreciated that the sensor system 500 may in some other embodiments be configured to process the value of the voltage drop across the second resistor 504 from the potential divider to determine the temperature of the vaporizer 40.

In the above implementations of the sensor system 500, in accordance with some embodiments, such as the embodiment shown in FIGS. 7A and 7B, the sensor system 500 may comprise a control element 506 for determining the temperature of the vaporizer 40 based off any recorded measurement/voltage drop across each resistor(s) 502;504. In a particular embodiment, as also shown in the embodiment of FIGS. 7A and 7B, the control element 506 may be connected to each resistor(s) 502;504 via connection leads 508, which can deliver power between the control element 506 and each resistor(s) 502;504.

The sensor system 500 is also configured to be provided with a power supply for powering the sensor system 500. In accordance with some embodiments, such as that shown in FIGS. 7A and 7B, the aerosol provision system 1 may be provided with the first power supply 16 configured to provide electrical power to the vaporizer 40, either by direct current or alternating current. Equally, in some embodiments, the aerosol provision system 1 may comprise a second power supply 17 for providing electrical power to the sensor system 500.

In some embodiments, noting the power requirements of the sensor system 500 may be notably less than the power requirements for the vaporizer 40, the second power supply 17 may be independent of the first power supply 16, as is the case for the embodiment shown in FIGS. 7A and 7B. In a particular embodiment, the first power supply 16 may comprise a first battery and the second power supply 17 may comprise a second battery. In that embodiment, noting the relative power requirements of the sensor system 500 and the vaporizer 40, the first battery may have a maximum capacity which is more than the maximum capacity of the second battery. The second power supply 17 may be configured to provide direct current, or alternating current, to the sensor system 500.

The sensor system 500 described herein may be applicable to any aerosol provision system 1 whereby the vaporizer 40 is configured for vaporising aerosolizable material from a reservoir 31 of such aerosolizable material. In that respect, any delivery mechanism may be provided for transferring the aerosolizable material from the reservoir 31 to the vaporizer 40. In accordance with some embodiments, this delivery mechanism may comprise the wick 42. In such embodiments, the wick 42 is configured to receive the aerosolizable material from the reservoir 31, wherein the vaporizer 40 is configured to vaporize the aerosolizable material received in the wick 42. Such an embodiment where the wick 42 is present is shown in the embodiment of FIGS. 7A and 7B.

Where the wick 42 is present, it will be appreciated that the wick 42 may take several forms. In accordance with some embodiments, such as the aerosol provision systems shown in FIGS. 1-6B, the wick 42 may comprise a capillary wick. Equally, the wick 42 may comprise a fibrous material, and/or in some embodiments may comprise a ceramic material as shown in the embodiment of FIGS. 7A and 7B.

Where the wick 42 comprises a ceramic material, in some particular embodiments thereof, the vaporizer 40 may comprise a conductive material located on an external surface of the wick 42, as shown in FIG. 7B. Such conductive material may appreciably take any required shape on the surface of the wick 42, e.g. a spiral pattern; a raster pattern; or a zig-zag pattern such to allow the vaporizer 40 to efficiently vaporize the aerosolizable material in the wick 42. As will be appreciated, the conductive material may be connected to the connection leads 41 which deliver power to the vaporizer 40, as shown in the embodiment of FIGS. 7A and 7B.

Irrespective of the material composition of the wick 42, where such a wick 42 is present, in accordance with some embodiments thereof (such as that shown in FIG. 7B), each resistor 502;504 from the sensor system 500 may be located on the wick 42, and in some very particular embodiments may be located on an external surface of the wick 42. By locating each resistor 502;504 on the wick 42, this may allow the sensor system 500 to not only determine the temperature of the vaporizer 40, but also may allow the sensor system 500 to be configured to detect the temperature of the wick 42 itself. In that respect, in much the same way that the sensor system 500 may be able to determine the temperature of the vaporizer 40, using similar techniques the sensor system 500 may be able to determine a temperature of the wick 42 based on any recorded measurement from the each resistor 502;504, and/or based on the voltage drop across the resistor(s). Thus in accordance with some embodiments of the aerosol provision system 1 described herein, the sensor system 500 may be configured for detecting the temperature of the wick 42 in addition to/instead of detecting the temperature of the vaporizer 40.

Conscious of the above disclosure, in terms of the exact empirical values for any of the first resistors 502 and/or the second resistor 504, and the exact empirical formula employed be the sensor system 500 to determine the temperature of the vaporizer 40 and/or the wick 42 based off any recorded measurement/voltage drop across the resistor(s) 502;504, it will be fully appreciated that these values/formulas will be entirely dependant on the separation between, and the materials used for, the vaporizer 40 and each resistor(s) 502;504 (and any wick 42, where the wick 42 is present). Accordingly, these values and formulas may be predetermined by, and/or pre-supplied to, the sensor system 500 as part of any given setup in the aerosol provision system 1. In that respect, and in some very particular embodiments, any such value(s) or formulas may be stored in a memory of the sensor system 500, or stored in a memory which the control element 506 can access. In any case however, and whatever these exact empirical values, the fundamental operation of the sensor system 500 remains the same in all such embodiments, namely to detect the temperature of the vaporizer 40 (and/or the wick 42) using the at least one resistor 502.

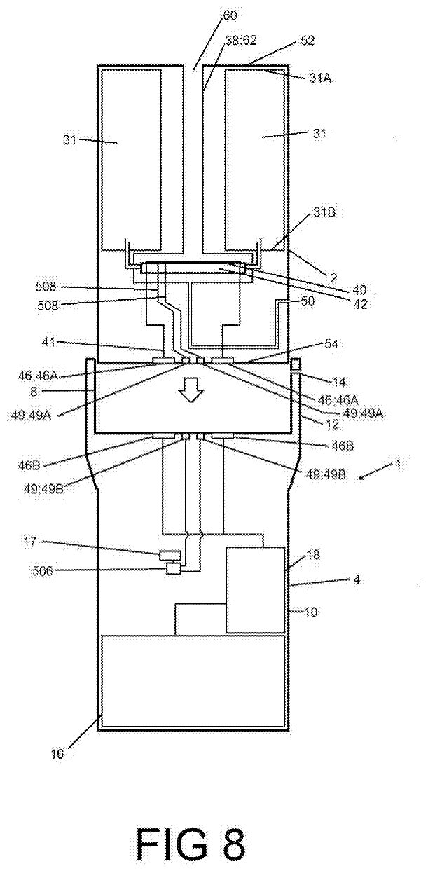

Appreciating the foregoing, it is envisaged that the sensor system 500 may be located in a number of different aerosol provision system 1, and in a number of different configurations with respect to the remaining components of each such aerosol provision system 1. In accordance with some embodiments, such as that shown in FIG. 8 (which may similarly employ the aspects of the sensor system 500 illustrated in FIG. 7B), the sensor system 500 may be located in an aerosol provision system 1 comprising the cartridge and the control unit 4. In such embodiments, the reservoir 31, the vaporizer 40, and the first resistor 502 may be located in the cartridge 2. In such embodiments, the control unit 4 may then comprise the cartridge receiving section 8 that includes the interface arranged to cooperatively engage with the cartridge 2 so as to releasably couple the cartridge 2 to the control unit 4.

Equally, in some embodiments, the entirety of the sensor system 500 may be located in the cartridge 2. In such embodiments, there may be provided, at least, the cartridge 2 for the aerosol provision system 1 comprising the cartridge 2 and the control unit 4, wherein the cartridge 2 comprise the reservoir 31 for aerosolizable material; the vaporizer 40 for vaporising aerosolizable material from the reservoir 31; and the sensor system 500, separate from the vaporizer 40, for detecting the temperature of the vaporizer 40, wherein the sensor system 500 comprises the first resistor 502.

Furthermore, in accordance with some embodiments, such as the embodiment shown in FIG. 8 in conjunction with FIG. 7B, the control unit 4 may comprise a portion of the sensor system 500. In a particular embodiment thereof, as shown in FIG. 8, the control unit 4 may comprise the control element 506 and/or the second power supply 17.

In embodiments where the control unit 4 comprises a portion of the of the sensor system 500, a mechanism may be provided for transferring power and/or any signals between the portion of the sensor system 500 in the control unit 4, and the remaining portion of the sensor system 500 in the cartridge 2. In that respect therefore, and in accordance with some embodiments such as that sown in FIG. 8, a wired connection may be provided between the cartridge 2 and the control unit 4, and which extends across the interface end 54 and corresponding receptacle 8 between the control unit 4 and the cartridge 2. In some particular embodiments thereof, the cartridge 2 may then comprise a first sensor contact electrode(s) 49;49A for engaging with a second sensor contact electrode(s) 49;49B from the interface from the control unit 4 for transferring power/signals between the portion of the sensor system 500 in the control unit 4, and the remaining portion of the sensor system 500 in the cartridge 2. It will be appreciated that in such embodiments, a wireless connection could equally be used to bridge any required power/signals between any portion of the sensor system 500 in the control unit 4, and any remaining portion of the sensor system 500 in the cartridge 2, such to obviate the need for any sensor contact electrodes 49.

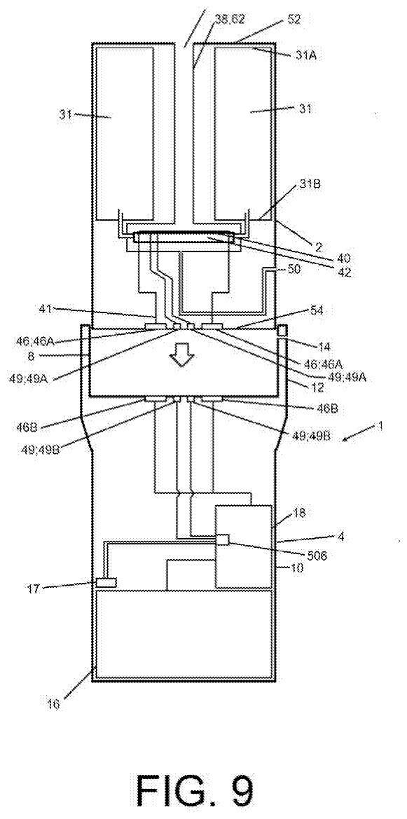

In accordance with some embodiments, such as that shown in FIG. 9 (in conjunction with FIG. 7B), it may be that the control circuitry 18 from the aerosol provision system comprises a portion of the sensor system 500, such as (but not limited to) any provided control element 506.

From the foregoing, it will be appreciated that the sensor system 500 may be configured to provide an output signal containing data related to the temperature of the vaporizer 40. Using this output signal, the aerosol provision system 1 may be then configured to perform a variety of different actions in response.

For instance, in accordance with some embodiments, the control circuitry 18 may be configured to process the data from the output signal; and generate, in response to processing the data from the output signal, a first control signal for controlling the operation of the first power supply 16. Where the sensor system 500 is separate from the control circuitry 18 (e.g. as shown in FIGS. 7A and 8, but not the embodiment of FIG. 9), it will be appreciated in such instances that the output signal may be sent from the sensor system 500 (and/or any provided control element 506) to the control circuitry 18, using either a wired connection, or a wireless connection, as required.

In accordance with some particular embodiments, the first control signal may comprise a command to vary the amount of power provided by the first power supply 16 to the vaporizer 40, or may comprise a command to stop providing power to the vaporizer 40 from the first power supply 16. Such a first output signal might be required, in certain embodiments, where the data from the output signal 18 is indicative of a temperature from the vaporizer 40 which exceeds a predetermined threshold temperature, which in some particular embodiments may be a predetermined threshold temperature which is stored in a memory of the control circuitry 18.

The control circuitry 18 may be further configured, in accordance with some embodiments, to generate, in response to processing the data from the output signal, a second control signal for controlling the operation of the second power supply 17. In accordance with some particular embodiments, the second control signal may comprise a command to stop providing power to the sensor system 500 from the second power supply 17. Such a second control signal may be particularly useful in instances where the data from the output signal 18 is indicative of a temperature from the vaporizer 40 exceeding the predetermined threshold temperature. In such instances, the control circuitry 18 may be then configured to switch off the sensor system 500, alongside any corresponding command to stop providing power to the vaporizer 40 (e.g. via the first control signal).

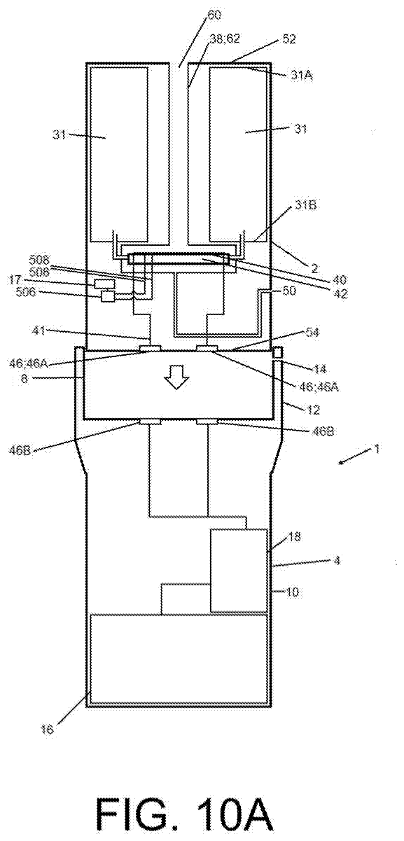

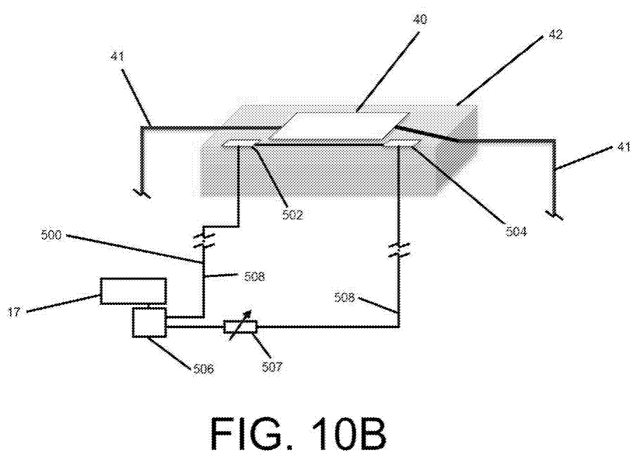

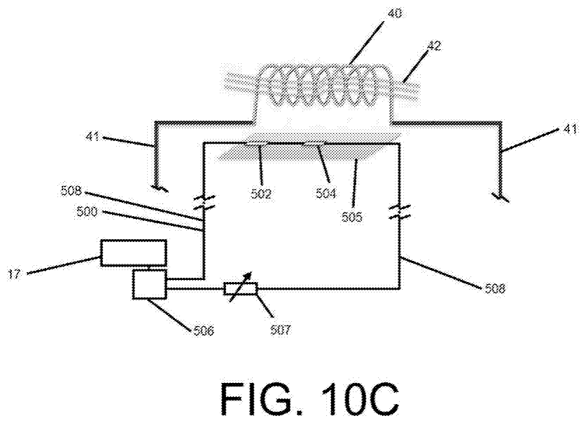

With reference to FIG. 10A, there is shown schematically a cross section view of a modified version of the aerosol provision system 1, including the cartridge 2 and the control unit 4. The aerosol provision system 1; cartridge 2; and control unit 4 shown in FIG. 10A are based on the construction of the corresponding aerosol provision system 1; cartridge 2; and control unit 4; shown in FIGS. 1-6B, and comprise similar components as set out by the reference numerals that are common to both sets of Figures. For instance, the cartridge 2 from FIG. 10A comprises a vaporizer 40, and defines a reservoir 31 which extends around an aerosol outlet tube 38. In accordance with such embodiments, the reservoir 31 may be annular, and is configured for containing aerosolizable material for aerosolising. Similarly, the control unit 4 from FIG. 10A may comprise the plastic outer housing 10 including the receptacle wall 12 that defines the receptacle 8 for receiving the end of the cartridge 2. The control unit 4 from FIG. 10A may also comprise the control circuitry 18 and the power supply/battery 16. In such embodiments, the cartridge 2 may comprise a first contact electrode(s) 46;46A for engaging with a second contact electrode(s) 46;46B from the interface from the control unit 4 for transferring power between the control circuitry 18 in the control unit 4 and the vaporizer 40 in the cartridge 2.

In accordance with some embodiments, such as this embodiment shown in FIG. 10A, the reservoir 31 may comprise a first end 31A which is proximal the aerosol outlet 60 of the cartridge 2, and a second end 31B which is proximal the vaporizer 40.

Relating to FIG. 10A is FIG. 10B which shows a schematic view of the region of the vaporizer 40 from FIG. 10A, and which also illustrates an embodiment of sensor system 500 which may be introduced into any of the aerosol provision systems 1 described herein. As will be described, the sensor system 500 is for determining the temperature of the vaporizer 40.

In the above respect therefore, FIGS. 10A and 10B illustrate an embodiment of aerosol provision system 1 which comprises, in a broad sense, a reservoir 31 for aerosolizable material; a vaporizer 40 for vaporising aerosolizable material from the reservoir 31; and a sensor system 500, separate from the vaporizer 40, for determining the temperature of the vaporizer 40, wherein the sensor system 500 comprises a capacitor and an inductor 504. As indicated in the embodiment shown in FIG. 10B, the sensor system 500 is notionally separate from the vaporizer 40, in so far as the capacitor 502 and the inductor 504 from the sensor system 500 may be physically spaced from the vaporizer 40, and in so far as determining the temperature of the vaporizer 40 may be determined off data from the sensor system 500, as opposed to off any data from the vaporizer 40 itself, as will be described.

In the above respect, there currently exists sensor arrangements which determine the temperature of the vaporizer 40 by monitoring the resistance value of the vaporizer 40 itself. From this resistance value of the vaporizer, the sensor arrangement can then determine the temperature of the vaporizer 40, noting the resistance of the vaporizer 40 is directly related to the temperature of the vaporizer 40. Whilst such arrangements currently exist, these sensor arrangements notionally rely on the higher power circuitry which is also used to power the vaporizer 40.

Conscious of the above, the sensor system 500 as described herein is contrastingly separate from the vaporizer 40, in so far as any capacitor 502 and inductor 504 from the sensor system 500 may be physically spaced from the vaporizer 40, and in so far as determining the temperature of the vaporizer 40 may be determined off reactive/impendence data from the sensor system 500 rather than off a resistance value of the vaporizer 40 itself.

With the above in mind and starting with the capacitor 502 and the inductor 504, the capacitor 502 and the inductor 504 in accordance with some embodiments may be provided in a location proximate to the vaporizer 40, such that their properties or output may be impacted by any changes in the temperature of the vaporizer 40. From this location, the sensor system 500 may be then configured to determine the temperature of the vaporizer 40 based on a recorded measurement from each of the capacitor 502 and the inductor 504, or from other measurements relating to the sensor system 500 as a whole as will be described. Conscious of the above, and in accordance with some particular embodiments, the capacitor 502 and the inductor 504 may be each located within a predetermined distance from the vaporizer 40, to better ensure that their properties or output are suitably impacted by any changes in the temperature of the vaporizer 40. This predetermined distance will depend on the aerosol provision system 1, but in accordance with some particular embodiments, the predetermined distance may be any of 50 mm; 45 mm; 40 mm; 35 mm; 30 mm; 25 mm; 20 mm; 15 mm; or 10 mm; or 5 mm (depending on the size/physical dimensions of the aerosol provision system 1).

In accordance with some embodiments, the sensor system 500 may be configured to determine a capacitance value of the capacitor 502 and an inductance value of the inductor 504, and accordingly process the capacitance value and the inductance value to determine the temperature of the vaporizer 40. In that respect, on the basis the sensor system 500 may be configured to provide a predetermined amount of power to the capacitor 502 and the inductor 504, the reactive output or reactance of the capacitor 502 and the inductor 504 will be influenced by the temperature of the nearby vaporizer 40, whose temperature itself will be dependent on the remaining amount of aerosolizable material in the vicinity of the vaporizer 40. In that respect, as the remaining amount of aerosolizable material in the vicinity of the vaporizer 40 starts to diminish, e.g. once dry out conditions start to occur, this will cause the temperature of the vaporizer 40 to increase for a predetermined amount of power supplied thereto, which will cause a corresponding change in the capacitance and inductance of the nearby capacitor and inductor, whose properties and/or output will be impacted by the temperature change in the vaporizer 40.

Accordingly, by determining the capacitance value of the capacitor 502, and the inductance value of the inductor 504, or put differently by determining the reactance of the sensor system 500, this may allow the sensor system 500 to ultimately determine the temperature of the vaporizer 40.

In accordance with some embodiments, once the sensor system 500 has determined the capacitance value of the capacitor 502, and the inductance value of the inductor 504, the sensor system 500 may be configured to determine a resonant frequency parameter, such as the resonant frequency of the sensor system 500 circuit, from the capacitance value and the inductance value. In a particular embodiment where the capacitor 502 and 504 are connected in series, such as the embodiment shown in FIG. 10B (and also FIG. 10C as will be described), the resonant frequency parameter may be the resonant frequency f0 of the sensor system 500, and may be determined by Formula A:

$${f}_{0} = \frac{1}{2 π \sqrt{LC}} \qquad Formula A$$

Where: f0=resonant frequency in Hertz;
L=determined inductance value of the inductor 504 in Henrys; and
C=determined capacitance value of the capacitor 502.in Farads.

It will be appreciated that the resonant frequent parameter need not expressly be the resonant frequency f0 of the sensor system 500, and/or necessarily be the exact result of above Formula A-which is specific to the capacitor 502 and the inductor 504 being connected in series. Indeed, it is envisaged that the resonant frequent parameter could be any parameter related to both the capacitance value and the inductance value, or some other property relating to the capacitance of the capacitor an the inductance of the inductor 504, depending on the arrangement of the capacitor 502 and the inductor 504 in the sensor system 500 (e.g. depending on whether the capacitor 502 and the inductor 504 are connected in series, or possibly connected in parallel).

Notionally however, both the capacitance value and the inductance value in the above embodiments should be utilised, in so far as only utilising one of these two values, or utilising a sensor system 500 which only comprises one of the capacitor 502 and the inductor 504, may provide an insufficient resolution in the sensor system 500 to be able to adequately determine variations in the temperature of the vaporizer 40.

It will be appreciated in the above embodiments where the resonant frequency parameter is determined, this resonant frequency parameter could be determined directly without the need to expressly determine the capacitance value and the inductance value. In that respect, and in accordance with some embodiments, the resonant frequency parameter may be determined by the sensor system 500 applying a predetermined amount voltage to the sensor system 500, at a plurality of different frequencies, and comparing the voltage response across the capacitor 502 and the inductor 504 for each frequency to determine the resonant frequency parameter (such as the resonant frequency f0). In accordance with some embodiments, the predetermined amount voltage may be provided by a power supply to the sensor system 500, such as the second power supply 17 as will be described.

However the resonant frequency parameter is determined, the sensor system 500 may be configured to process the resonant frequency parameter to determine the temperature of the vaporizer 40. This processing may be achieved in a variety of different ways.

In that respect, and in accordance with some embodiments, the sensor system 500 may be configured to process the resonant frequency parameter in a formula to determine the temperature of the vaporizer 40. In such instances, the exact empirical formula employed by the sensor system 500 may be substantially dependant on the separation between, and the materials used for, the vaporizer 40 and the capacitor 502/inductor 504 (and their corresponding thermal/magnetic properties). The formula may also be specific to the power expected to be delivered to the vaporizer 40 in normal use. Accordingly, the formula may be predetermined by, and/or pre-supplied to, the sensor system 500 as part of any given setup in the aerosol provision system 1. In that respect, and in some very particular embodiments, any formula may be stored in a memory of the sensor system 500, or stored in a memory which a control element 506 from the sensor system 500 may be configured to access.

Aside from using a formula, the sensor system 500 may be configured to use a look-up table which comprises of a plurality of predetermined resonant frequency parameters, wherein each predetermined resonant frequency parameter from the look-up table comprises an associated predetermined temperature value from the look-up table. Such a look-up table, in such embodiments, may be specific to the separation between, and the materials used for, the vaporizer 40 and the capacitor 502/inductor 504 (and their corresponding thermal/magnetic properties). The look up table may also be specific to the power expected to be delivered to the vaporizer 40 in normal use. Accordingly, any such look-up may be stored in a memory of the sensor system 500, or stored in a memory which the control element 506 from the sensor system 500 may be configured to access, where such a control element 506 is present.

In embodiments where the look-up table is employed, the sensor system 500 may be configured to match the resonant frequency parameter with one of a plurality of predetermined resonant frequency parameters stored in the look-up table. In response to matching the resonant frequency parameter with one of the plurality of predetermined resonant frequency parameters, the sensor system 500 may be then configured to utilise the associated predetermined temperature value for the matched predetermined resonant frequency parameter to determine the temperature of the vaporizer 40.

In accordance with some embodiments, and depending on the number of plurality of predetermined resonant frequency parameters stored in the look-up table, it may be in some embodiments that the resonant frequency parameter may not match any of the plurality of predetermined resonant frequency parameters stored in the look-up table In such events, in response to not matching with one of a plurality of predetermined resonant frequency parameters stored in the look-up table, the control circuitry may be further configured to identify a first predetermined resonant frequency parameter, from the predetermined resonant frequency parameters, which is less than the resonant frequency parameter; and also identify a second predetermined resonant frequency parameter, from the predetermined resonant frequency parameters, which is greater than the resonant frequency parameter. Following that determination, the sensor system may be then configured to interpolate between the first predetermined resonant frequency parameter and the second predetermined resonant frequency parameter, using the resonant frequency parameter, to determine an interpolated temperature value which is between the associated predetermined temperature values for the first and second predetermined resonant frequency parameters. In that way, the sensor system 500 may then utilise the interpolated temperature value to determine the temperature of the vaporizer 40. Any applicable interpolation technique may be employed in these instances, which purely as non-limiting examples may include linear interpolation in some embodiments, or polynomial interpolation in other embodiments.

In the above implementations of the sensor system 500, in accordance with some embodiments, such as the embodiment shown in FIGS. 10A and 10B (and also FIG. 10C), as alluded to above, the sensor system 500 may comprise the control element 506 for determining the temperature of the vaporizer 40 based off any recorded measurements from the sensor system 500, such as the capacitance value from the capacitor 502 and the inductance value from the inductor 504. In a particular embodiment, as shown in FIGS. 10A-10C, the control element 506 may be connected to the capacitor 502 and the inductor 504 via connection leads 508, which can deliver power between the control element 506 and the capacitor 502/inductor 504.

Staying with the sensor system 500, as noted above the sensor system 500 is provided with both the capacitor 502 and the inductor 504, which in accordance with some embodiments (such as those from FIGS. 10B and 10C) are connected in series. In accordance with some embodiments, the sensor system 500 may also be provided with a tuning resistor 507, which could either be fixed resistor or a variable resistor, such to turn the sensor system 500 in such embodiments from an LC circuit to an RLC circuit, as may be required.

The sensor system 500 is also configured to be provided with a power supply for powering the sensor system 500. In accordance with some embodiments (such as the embodiment shown in FIG. 10A), the aerosol provision system 1 may be provided with the first power supply 16 configured to provide electrical power to the vaporizer 40, either by direct current or alternating current. Equally, in some embodiments, the aerosol provision system 1 may comprise a second power supply 17 for providing electrical power to the sensor system 500 (as shown in FIGS. 10B and 10C). In some embodiments, noting the power requirements of the sensor system 500 may be notably less than the power requirements for the vaporizer 40, the second power supply 17 may be independent of the first power supply 16, as is the case for the embodiments shown in FIGS. 10A-10C. In a particular embodiment, the first power supply 16 may comprise a first battery and the second power supply 17 may comprise a second battery. In that embodiment, noting the relative power requirements of the sensor system 500 and the vaporizer 40, the first battery may have a maximum capacity which is more than the maximum capacity of the second battery. Noting the reactive features from the sensor system 500, including the capacitor 502 and inductor 504, the second power supply 17 may be configured to provide alternating current, to the sensor system 500.

The sensor system 500 described herein may be applicable to any aerosol provision system 1 whereby the vaporizer 40 is configured for vaporising aerosolizable material from a reservoir 31 of such aerosolizable material. In that respect, any delivery mechanism may be provided for transferring the aerosolizable material from the reservoir 31 to the vaporizer 40. In accordance with some embodiments, this delivery mechanism may comprise the wick 42. In such embodiments, the wick 42 is configured to receive the aerosolizable material from the reservoir 31, wherein the vaporizer 40 is configured to vaporize the aerosolizable material received in the wick 42.

Where the wick 42 is present, it will be appreciated that the wick 42 may take several forms. In accordance with some embodiments, such as the aerosol provision systems shown in FIGS. 1-6B and 10C, the wick 42 may comprise a capillary wick. Equally, the wick 42 may comprise a fibrous material, and/or in some embodiments may comprise a ceramic material as shown in the embodiment of FIG. 10B.

Where the wick 42 comprises a ceramic material, in some particular embodiments thereof, the vaporizer 40 may comprise a conductive material located on an external surface of the wick 42, as shown in FIG. 10B. Such conductive material may appreciably take any required shape on the surface of the wick 42, e.g. a spiral pattern; a raster pattern; or a zig-zag pattern such to allow the vaporizer 40 to efficiently vaporize the aerosolizable material in the wick 42. As will be appreciated, the conductive material may be connected to the connection leads 41 which deliver power to the vaporizer 40, as shown in the embodiments of FIGS. 10A-10C.

Irrespective of the material composition of the wick 42, where such a wick 42 is present, in accordance with some embodiments thereof (such as that shown in FIG. 10B), the capacitor 502 and the inductor 504 from the sensor system 500 may be located on the wick 42, and in some very particular embodiments may be located on an external surface of the wick 42. By locating capacitor 502 and the inductor 504 on, or sufficiently close to, the wick 42, this may allow the sensor system 500 to not only determine the temperature of the vaporizer 40, but also may allow the sensor system 500 to be configured to determine the temperature of the wick 42 itself. In that respect, in much the same way that the sensor system 500 may be able to determine the temperature of the vaporizer 40, using similar techniques the sensor system 500 may be able to determine a temperature of the wick 42 based on any recorded measurement from the capacitor 502 and the inductor 504. Thus in accordance with some embodiments of the aerosol provision system 1 described herein, the sensor system 500 may be configured for determining the temperature of the wick 42 in addition to/instead of determining the temperature of the vaporizer 40.

Whether a wick 42 or not is present, in accordance with some embodiments, such as that shown in the embodiment FIG. 10B, the sensor system 500 may comprise a suitable substrate on which the capacitor 502 and the inductor 504 (and even the resistor 507, where such a resistor 507 is present) may be located, e.g. for positioning the capacitor 502 and the inductor 504 proximate the vaporizer 40. In accordance with some embodiments, such as that shown in FIG. 10C, at least a portion of the sensor system 500 may be mounted onto a printed circuit board 505, which may be located proximate the vaporizer 40 and/or the wick 42 (where such a wick 42 is present). In some embodiments, this printed circuit board 505 may be deposited onto an external surface of the wick 42.

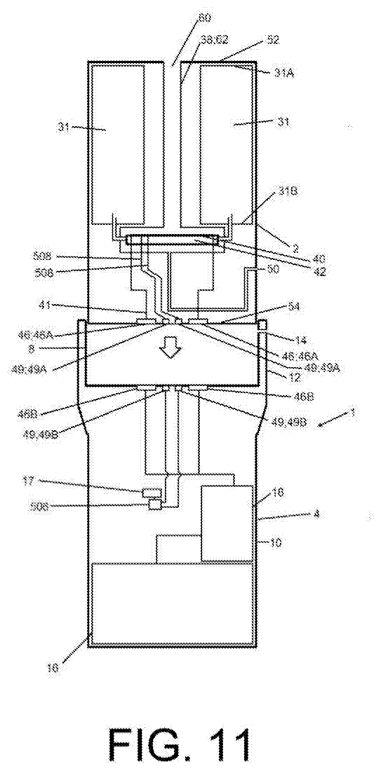

Appreciating the foregoing, it is envisaged that the sensor system 500 may be located in a number of different aerosol provision system 1, and in a number of different configurations with respect to the remaining components of each such aerosol provision system 1. In accordance with some embodiments, such as that shown in FIG. 11 (which may similarly employ the aspects of the sensor system 500 illustrated in FIG. 10B or FIG. 10C), the sensor system 500 may be located in an aerosol provision system 1 comprising the cartridge and the control unit 4. In such embodiments, the reservoir 31, the vaporizer 40, the capacitor 502 and the inductor 504 may be located in the cartridge 2. In such embodiments, the control unit 4 may then comprise the cartridge receiving section 8 that includes the interface arranged to cooperatively engage with the cartridge 2 so as to releasably couple the cartridge 2 to the control unit 4.

Equally, in some embodiments, the entirety of the sensor system 500 may be located in the cartridge 2. In such embodiments, there may be provided, at least, the cartridge 2 for the aerosol provision system 1 comprising the cartridge 2 and the control unit 4, wherein the cartridge 2 comprise the reservoir 31 for aerosolizable material; the vaporizer 40 for vaporising aerosolizable material from the reservoir 31; and the sensor system 500, separate from the vaporizer 40, for determining the temperature of the vaporizer 40, wherein the sensor system 500 comprises the capacitor 502 and the inductor 504.

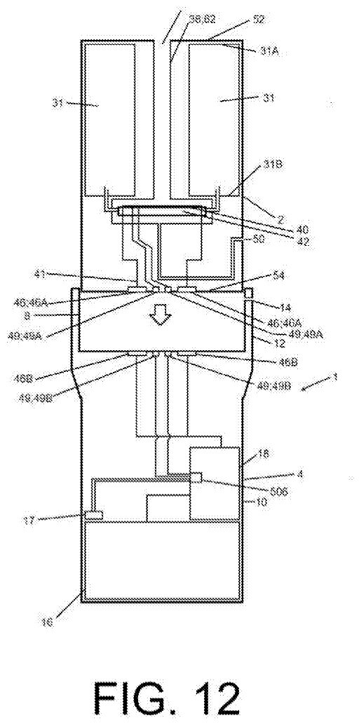

Furthermore, in accordance with some embodiments, such as the embodiment shown in FIG. 12 in conjunction with FIG. 10B (or in conjunction with FIG. 10C), the control unit 4 may comprise a portion of the sensor system 500. In a particular embodiment thereof, as shown in FIG. 12, the control unit 4 may comprise the control element 506 and/or the second power supply 17.

In embodiments where the control unit 4 comprises a portion of the of the sensor system 500, a mechanism may be provided for transferring power and/or any signals between the portion of the sensor system 500 in the control unit 4, and the remaining portion of the sensor system 500 in the cartridge 2. In that respect therefore, and in accordance with some embodiments such as that sown in FIG. 11, a wired connection may be provided between the cartridge 2 and the control unit 4, and which extends across the interface end 54 and corresponding receptacle 8 between the control unit 4 and the cartridge 2. In some particular embodiments thereof, the cartridge 2 may then comprise a first sensor contact electrode(s) 49;49A for engaging with a second sensor contact electrode(s) 49;49B from the interface from the control unit 4 for transferring power/signals between the portion of the sensor system 500 in the control unit 4, and the remaining portion of the sensor system 500 in the cartridge 2. It will be appreciated that in such embodiments, a wireless connection could equally be used to bridge any required power/signals between any portion of the sensor system 500 in the control unit 4, and any remaining portion of the sensor system 500 in the cartridge 2, such to obviate the need for any sensor contact electrodes 49.

In accordance with some embodiments, such as that shown in FIG. 12 (in conjunction with FIG. 10B or in conjunction with FIG. 10C), it may be that the control circuitry 18 from the aerosol provision system comprises a portion of the sensor system 500, such as (but not limited to) any provided control element 506.

From the foregoing, it will be appreciated that the sensor system 500 may be configured to provide an output signal containing data related to the temperature of the vaporizer 40. Using this output signal, the aerosol provision system 1 may be then configured to perform a variety of different actions in response.

For instance, in accordance with some embodiments, the control circuitry 18 may be configured to process the data from the output signal; and generate, in response to processing the data from the output signal, a first control signal for controlling the operation of the first power supply 16. Where the sensor system 500 is separate from the control circuitry 18 (e.g. as shown in FIGS. 10A and 11, but not the embodiment of FIG. 12), it will be appreciated in such instances that the output signal may be sent from the sensor system 500 (and/or any provided control element 506) to the control circuitry 18, using either a wired connection, or a wireless connection, as required.

In accordance with some particular embodiments, the first control signal may comprise a command to vary the amount of power provided by the first power supply 16 to the vaporizer 40, or may comprise a command to stop providing power to the vaporizer 40 from the first power supply 16. Such a first output signal might be required, in certain embodiments, where the data from the output signal 18 is indicative of a temperature from the vaporizer 40 which exceeds a predetermined threshold temperature, which in some particular embodiments may be a predetermined threshold temperature which is stored in a memory of the control circuitry 18.

The control circuitry 18 may be further configured, in accordance with some embodiments, to generate, in response to processing the data from the output signal, a second control signal for controlling the operation of the second power supply 17. In accordance with some particular embodiments, the second control signal may comprise a command to stop providing power to the sensor system 500 from the second power supply 17. Such a second control signal may be particularly useful in instances where the data from the output signal 18 is indicative of a temperature from the vaporizer 40 exceeding the predetermined threshold temperature. In such instances, the control circuitry 18 may be then configured to switch off the sensor system 500, alongside any corresponding command to stop providing power to the vaporizer 40 (e.g. via the first control signal).

With regard to the construction of the vaporizer 40 which might be used with the sensor system 500 herein described, it will be appreciated that the vaporizer 40 may take a variety of different forms. In that respect, and in accordance with some particular embodiments, the vaporizer 40 may comprise a heating element such as a heating coil. In accordance with some particular embodiments where the wick 42 is present, in such embodiments the heating coil may be coiled, and/or extend around, the wick 42 (e.g. as shown in FIG. 10C). Equally, and in accordance with some other embodiments, the vaporizer 40 might be located on a wick 42 comprising a ceramic material (as shown in FIG. 10B). In accordance with some particular embodiments thereof, the vaporizer 40 could be printed in a particular pattern on a surface of the wick 42, such as raster pattern or spiral pattern as explained previously.

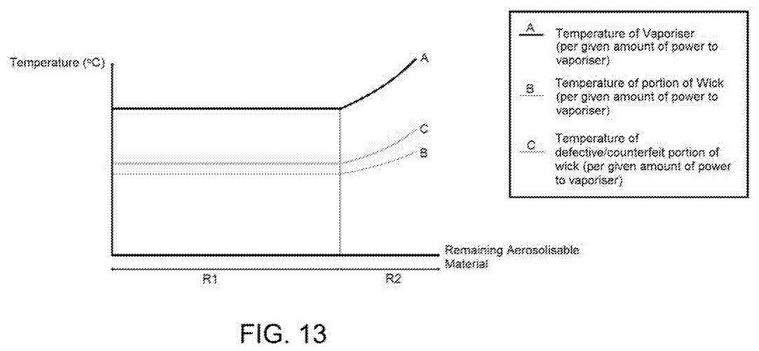

With reference to FIG. 13, there is shown a plot of temperature in various components of the aerosol provision system 1 against the remaining amount of aerosolizable material in the reservoir 31 of the aerosol provision system 1 (for a given amount of power supplied to the vaporizer 40), which may have applications in accordance with some of the embodiments of aerosol provision system 1 described herein, such as any of the embodiments described with reference to FIGS. 1-6B. As shown in this plot from FIG. 13, there is first shown an expected temperature change in the temperature of the vaporizer 40 as the remaining amount of aerosolizable material in the reservoir 31 diminishes (the X-axis representing a diminishing amount of aerosolizable material as the axis moves from left-to-right). This expected temperature change in the vaporizer 40 is indicated as line A. Also shown is an expected temperature change in the temperature of the wick 42 as the remaining amount of aerosolizable material in the reservoir 31 diminishes. This expected temperature change in the wick 42 is indicated as line B. Finally, also shown in FIG. 13 is an expected temperature change in the temperature of an alternate wick 42 as the remaining amount of aerosolizable material in the reservoir 31 diminishes, which may be indicative of a defective or counterfeit wick as will be described. This expected temperature change in this alternate wick 42 is indicated as line C.

In the above plot from FIG. 13, there is indicated two principal regions, namely a saturated region R1, where the wick 42 is saturated with aerosolizable material; and a dry out region R2, where the wick 42 is no longer saturated—for instance as a result of the aerosolizable material in the reservoir 31 starting to run out.

In the saturated region R1, it may be expected that for a unit amount of power supplied to the vaporizer 40, the temperature in the vaporizer 40 and/or the wick 42 would remain substantially constant during any powering of the vaporizer 40 with this fixed amount of power. In that respect, whilst the wick 42 is saturated with aerosolizable material, for a given amount of power supplied to the vaporizer, the aerosolizable material in the saturated wick 42 may provide a constant cooling rate on the wick 42/vaporizer 40.

Naturally, one would expect the temperature of the vaporizer 40 to be higher than that of the wick 42, noting it is the vaporizer 40 that is being supplied with the power. This is therefore reflected in the plot from FIG. 13, where the temperature of the vaporizer (line A) is shown at a consistently higher temperature than the temperature of the wick (line B) or alternate wick (line C).

Once the aerosolizable material in the reservoir 31 starts to run out, such that the wick 42 can no longer be saturated with aerosolizable material, the wick 42 will then start to become dry. In that respect therefore, and as the wick 42 continues to dry out as the aerosolizable material in the reservoir 31 further diminishes, the cooling effect caused by the aerosolizable material from the wick 42 will similarly be reduced, thus causing the temperature of the vaporizer 40 to increase (for a given amount of power supplied to the vaporizer). An illustration of such an increase in temperature for the vaporizer is shown in line A from FIG. 13, as part of the dry out region R2. For similar reasons, in the dry out region R2, as the wick 42 begins to dry out, the temperature of the wick 42 or alternate wick 42 will begin to increase, as is reflected by respective lines B and C from FIG. 13.

In the above instances, the temperature response of the wick 42 for a given amount of power to the vaporizer 40 will be dependent on the composition and/or any defects in the wick 42.

Accordingly, by monitoring the temperature of a portion of the wick 42, and comparing this to the temperature of vaporizer 40, a system can be provided which allows for any irregularities in the wick 42 to be detected. In that respect therefore, by specifically comparing a parameter relating to a temperature of the wick 42 with that of a parameter relating to the temperature of the vaporizer 40 (e.g. as a ratio), rather than monitor a parameter of the temperature of the wick 42 in absolute terms, this allows the parameter relating to the temperature of the wick 42 to be normalised based on any amount of power supplied to the vaporizer 40.

In the above respect therefore, in accordance with some embodiments, there may be provided an aerosol provision system 1 comprising the reservoir 31 for aerosolizable material; the wick 42 configured to receive the aerosolizable material from the reservoir 31; and the vaporizer 40 for vaporising aerosolizable material in the wick 42. In accordance with such embodiments, there may also be provide the control circuitry 18, wherein the control circuitry is configured to: determine a first parameter relating to a temperature of the vaporizer 40, and determine a second parameter relating to a temperature of the wick 42. Based on this comparison, the control circuitry 18 may then generate an output signal between the first parameter and the second parameter as will be described.

In accordance with some embodiments, the control circuitry 18 may be configured to measure the resistance of the vaporizer 40, and generate first data related to the resistance of the vaporizer 40. In that way, the control circuitry may be then configured to process the first data to determine the first parameter. In such embodiments, it will be appreciated that the resistance could be directly measured by the control circuitry 18 in a number of different ways. For instance, for a given current supplied to the vaporizer 40, the control circuitry 18 may be configured to measure the voltage drop across the vaporizer 40.

In accordance with some other embodiments, the aerosol provision system 1 may comprise a first temperature sensor 190 for outputting a first signal containing first data related to the temperature of the vaporizer 40, wherein the control circuitry is further configured to receive the first signal from the first temperature sensor 190, and process the first data from the first signal to determine the first parameter.

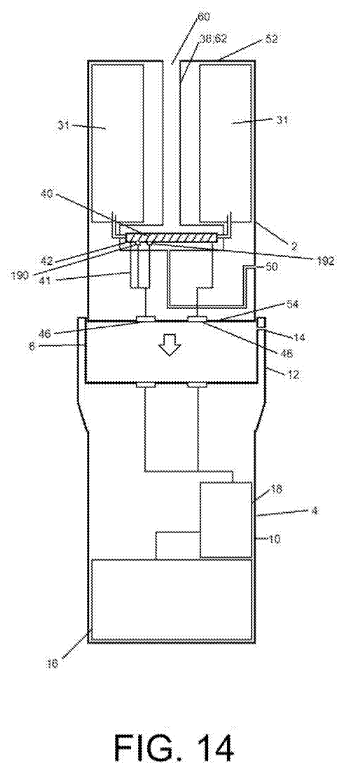

Such an embodiment is illustrated in the embodiment of FIG. 14, where the first temperature sensor 190 is located proximal or contacting the vaporizer 40, such that the first temperature sensor 190 can make a measurement of the temperature of the vaporizer 40. In that respect, the aerosol provision system 1 shown in FIG. 14 is based on the construction of the corresponding aerosol provision system 1; cartridge 2; and control unit 4; shown in FIGS. 1-6B, and comprises similar components as set out by the reference numerals that are common to both sets of Figures. For instance, the embodiment of FIG. 14 may comprise the cartridge 2 defines a reservoir 31 which extends around an aerosol outlet tube 38. In accordance with such embodiments, the reservoir 31 may be annular, and is configured for containing aerosolizable material for aerosolising. Similarly, the control unit 4 may comprise the plastic outer housing 10 including the receptacle wall 12 that defines the receptacle 8 for receiving the end of the cartridge 200. The control unit 4 may also comprise the control circuitry 18 and the power supply/battery 16.

Where the first temperature sensor 190 is present, it will be appreciated that this may either directly contact the vaporizer 40 for determining its temperature (as shown in the embodiment of FIG. 14), or comprise an alterative non-contact sensing mechanism (e.g. an optical sensor or infrared-energy sensor) for creating the first data related to the temperature of the vaporizer 40. In accordance with some particular embodiments, the first temperature sensor 190 may conveniently take the form of a resistor, such as proximal the vaporizer 40, whose resistance will be directly related to the temperature of the vaporizer 40.

In accordance with some embodiments, the wick 42 may comprise a second temperature sensor 192 for outputting a second signal containing second data related to the temperature of the wick 42. In such embodiments, the control circuitry 18 may be further configured to receive the second signal from the second sensor 192, and process the second data from the second signal to determine the second parameter. In the particular embodiment shown in FIG. 14, the second temperature sensor 192 is shown as contacting the wick 42 to allow it to create the second data related to the temperature of the wick 42. Though like the first temperature sensor 190 (where this is present), it will be appreciated that the second temperature sensor 192 may alternatively comprise a non-contact sensing mechanism (e.g. an optical sensor or infrared-energy sensor) for creating the second data related to the temperature of the wick 42. In accordance with some particular embodiments, the second temperature sensor may conveniently take the form of a resistor, such as in some very particular embodiments, located proximal to; embedded inside; or located on an external surface of the wick 42, and whose resistance will be directly related to the temperature of the wick 42. Conveniently, by locating the second temperature sensor 192 on the external surface of the wick 42, this may facilitate the construction of the wick 42 and the placement of the second temperature sensor 192.

Furthermore, locating the second temperature sensor 192 on the external surface of the wick 42 may further facilitate the powering/connection of the sensor 192 with other components from the aerosol provision system 1, including the control circuitry 18.

Irrespective of the exact sensing arrangement used to determine the temperature data relating to temperature of the vaporizer 40 and the wick 42, as noted above the control circuitry 18 is configured to determine a first parameter relating to the temperature of the vaporizer 40, and determine a second parameter relating to the temperature of the wick 42. In its simplest sense, the first parameter may the temperature of the vaporizer 40 in degrees Celsius (or Kelvin), and the second parameter may the temperature of the wick 42 in degrees Celsius (or Kelvin).

The control circuitry 18 is then configured to compare the first parameter and the second parameter, such that the result of the comparison may be indicative of the current status of the wick 42.

In the above respect for instance, and in accordance with some embodiments, the control circuitry 18 may be configured to divide one of the first and second parameters by the other of the first and second parameters to determine a ratio. In this way, in the saturated region R1, for a given or predetermined amount of power supplied to the vaporizer 40, one might expect a constant ratio between the first and second parameters respectively related to the temperatures of the vaporizer 40 and the wick 42. This can be seen from the plot of FIG. 13 between the lines A and B in the saturated region R1.

Outside the saturated region R1, such as in dry out region R2 where the temperatures of the vaporizer 40 and the wick 42 may be begin to increase at different rates, the ratio between the first and second parameters (respectively related to the temperatures of the vaporizer 40 and the wick 42) may thus start to deviate from an expected ratio otherwise seen whilst in the saturated region R1.

Conscious of the above, in accordance with some embodiments, and for a given aerosol provision system 1, the control circuitry 18 may be configured to determine an allowable/expected ratio between the first parameter and the second parameter corresponding to a ratio when the aerosol provision system is working correctly in the saturated region R1. In the event that the ratio then falls outside a predetermined range (which may be centred or located either side of the predetermined allowable/expected ratio) during the operation of the aerosol provision system 1, this may be then indicative that the wick 42 is startling to dry out, and/or that the aerosol provision system 1 has entered the dry out region R2.

In embodiments where the control circuitry 18 is configured to divide one of the first and second parameters by the other of the first and second parameters to determine the ratio, it will be appreciated in these embodiments that the ratio may be determined by dividing either the first parameter by the second parameter, or by dividing the second parameter by the first parameter. Either way, the predetermined range may still be set such that is centred or located either side of the resultant ratio. In that respect therefore, the predetermined range may in some embodiments comprise a first predetermined value defining a lowermost end of the predetermined range, and/or may in some embodiments comprise a second predetermined value defining an uppermost end of the predetermined range.

To provide an example of the above embodiments, where the ratio is determined by dividing the first parameter by the second parameter, in such instances where any determined ratio exceeds the second predetermined value defining the uppermost end of the predetermined range, this may be indicative of the wick 42 starting to become dry, and the aerosol provision system 1 entering the dry out region R2.

Conversely, where the ratio is determined by dividing the second parameter by the first parameter, in such instances where any determined ratio falls below the first predetermined value defining the lowermost end of the predetermined range, this may be indicative of the wick starting to become dry, and the aerosol provision system 1 entering the dry out region R2.

In terms of the exact empirical values for any predetermined allowable/expected ratio; the predetermined range; the first predetermined value and/or the second predetermined value, it will be fully appreciated that these empirical values will be dependant on the separation between, and the materials used for, the vaporizer 40 and the wick 42. Accordingly, these values may be predetermined by, and/or pre-supplied to, the control circuitry 18 as part of any given setup in the aerosol provision system 1. In that respect, and in some very particular embodiments, any such value(s) may be stored in a memory of the control circuitry 18, or stored in a memory which the control circuitry 18 can access. In any case however, and whatever these exact empirical values, the fundamental operation of the control circuitry remains the same in all such embodiments, namely to compare the first parameter (such as the temperature of the vaporizer 40 in degrees Celsius (or Kelvin)), and the second parameter (such as the temperature of the wick 42 in degrees Celsius (or Kelvin)), and generate an output signal in the event that the comparison between the first parameter and the second parameter generates a result which is outside a predetermined range.

Aside from detecting dry out in the wick 42, the above functionality of the control circuitry 18 may also allow for the detection of a faulty wick 42. In that respect, in the event that a fault is present in the wick 42, this may cause the wick 42 to become uncharacteristically hot (or cold in some instances) compared with an otherwise unfaulty wick 42. In such eventualities, irrespective of whether the aerosol provision system 1 is in the saturated region R1 or the dry out region R2, for a given amount of power supplied to the vaporizer 40, the temperature of the wick 42 will be uncharacteristically higher (or lower) than what would be ordinarily expected, as is illustrated in the embodiment plot from FIG. 13 by line C. That being the case, in such instances the ratio between the first parameter and the second parameter for the faulty wick 42 would be different to that of the ratio between the first parameter and the second parameter for the wick 42. In that way the ratio for the faulty wick 42 may be determined by the control circuitry 18 as falling outside the predetermined range.

Equally, the above functionality of the control circuitry 18 may allow for the detection of a counterfeit/unauthorised wick 42 in much the same way as that of a faulty wick 42. In that respect, any counterfeit/unauthorised wick 42 may cause the wick 42 to have an uncharacteristically hotter (or colder in some embodiments-depending on the construction of the wick) compared with an otherwise legitimate/authorised wick 42. For illustrative purposes, a temperature response for an embodiment of counterfeit/unauthorised wick 42 is illustrated in the plot from FIG. 13 by line C. Like with a faulty wick 42, in such instances the ratio between the first parameter and the second parameter for the counterfeit/unauthorised wick 42 would be different to that of the ratio between the first parameter and the second parameter for the legitimate/authorised wick 42. In that way the ratio for the counterfeit/unauthorised wick 42 may be determined by the control circuitry as falling outside the predetermined range.

In the above embodiments, any such faulty/counterfeit/unauthorised wick 42 may have inferior properties compared with a correctly operating authorised wick 42, thus making it beneficial for the control circuitry 18 to be able to determine the presence of such wicks 42. Accordingly, in accordance with embodiments where the comparison between the first parameter and the second parameter falls generates a result which is outside a predetermined range, and/or in the event that the ratio falls outside a predetermined range, the control circuitry 18 may be configured to generate an output signal.

In accordance with some particular embodiments, the output signal may comprise a command to disable the operation of the aerosol provision system 1, or a command to disable the operation of the vaporizer 40. In such embodiments, the operation may be disabled for a predetermined period of time (e.g. 30 seconds or a minute), for instance to allow the relevant component(s) from the aerosol provision system 1 to cool down. Alternatively, in some embodiments, the operation may be disabled until the control circuitry 18 detects that a new cartridge 4 has been attached and/or that the amount of aerosolizable material in the reservoir 31 exceeds a predetermined amount.

In accordance with some embodiments, the output signal may comprise at least one of: an optical signal, an acoustic signal, and a haptic signal. To implement the above, as required, in accordance with some embodiments, the aerosol provision system 1 may further comprise any one or combination of an optic element (such as an LED), an acoustic element (such as a speaker) and a haptic feedback element (such as a vibrator). Appreciably, in some particular embodiments to those set out above, any such optical/acoustic/haptic feedback element(s) may be most conveniently located in the control unit 4, where such a cartridge2/control unit 4 arrangement is provided.

As described previously, and although not necessarily, in accordance with some embodiments (such as that shown in the embodiment of FIG. 14), the above techniques may be employed in an aerosol provision system 1 further comprising the cartridge 2 and the control unit 4, wherein the reservoir 31, the wick 42, and the vaporizer 40 are located in the cartridge 2. In such embodiments, the control unit 4 may comprise the cartridge receiving section 8 that includes an interface arranged to cooperatively engage with the cartridge 2 so as to releasably couple the cartridge 2 to the control unit 4, wherein the control unit 4 further comprises the power supply 16 and the control circuitry 18.

With regards to the composition/construction of the wick 42, in accordance with some particular embodiments, such as that shown in the embodiment of FIG. 14, the wick 42 and the vaporizer 40 may be configured such that the vaporizer 40 is coiled around the wick 42, since this arrangement conveniently allows for the vaporizer 40 to evenly heat the wick 42 across its length. It will be appreciated however that such a coiled arrangement is not applicable to all embodiments and that any other arrangement between the vaporizer 40 and the wick 42 may be employed. In that respect for example, and in accordance with some embodiments, the wick 42 may comprise a ceramic wick, which in accordance with some particular embodiments thereof, may have the vaporizer 40 printed/deposited onto a surface of the ceramic wick.

From the above described embodiments therefore, there is consequentially and similarly provided a method of monitoring temperatures in an aerosol provision system 1 comprising a reservoir 31 for aerosolizable material, a wick 42 configured to receive the aerosolizable material from the reservoir 31, and a vaporizer 40 for vaporising aerosolizable material in the wick 42. The method comprises control circuitry 18 from the aerosol provision system 1: determining a first parameter relating to a temperature of the vaporizer 40; determining a second parameter relating to a temperature of the wick 42; performing a comparison between the first parameter and the second parameter; and generating an output signal based on the comparison, for instance in that the event that the comparison between the first parameter and the second parameter generates a result which is outside a predetermined range.

In accordance with some embodiments of this method, and as has been described with reference to above FIGS. 13 and 14, the method may further comprises the control circuitry 18: measuring the resistance of the vaporizer 40; generating first data related to the resistance of the vaporizer 40; and processing the first data to determine the first parameter. In such embodiments, the method may then further comprise: outputting, from a temperature sensor 192, a signal containing second data related to the temperature of the wick 42; receiving, at the control circuitry 18, the signal from the temperature sensor 192; and processing, at the control circuitry 18, the second data from the signal to determine the second parameter.

In particular embodiments of the above methods, the steps of performing the comparison between the first parameter and the second parameter, and generating the output signal based on the comparison, may further comprise the control circuitry 18: dividing one of the first and second parameters by the other of the first and second parameters to determine a ratio, and generating the output signal in the event the ratio falls outside a predetermined range.

As may be applicable in accordance with some particular embodiments of these methods, the output signal may in such particular embodiments comprise a command to disable the operation of the aerosol provision system 1 or the operation of the vaporizer 40, or comprise any other command(s) as herein described.

In respect of any provided temperature sensor(s) 190;192 in the aerosol provision system 1, it will also be appreciated that any signal therefrom may be sent using either a wired or wireless connection between the control circuitry 18 and the sensor 190;192. In the particular embodiment shown in FIG. 14, a wired connection is provided between each of the first and second temperature sensors 190; 192 and the control circuitry 18, and which extends in the case of the sensors 190;192 being located in the cartridge 2 across the interface end 54 and corresponding receptacle 8 between the control unit 4 and the cartridge 2 via the contact electrodes 46.

In terms of how any of the first temperature sensor 190 and/or the second temperature sensor 192 described with reference to the above embodiments may be powered (if they are present at all), it will be appreciated that these sensors may be powered using either the power supply 16 (as shown in the embodiment of FIG. 14 via the contact electrodes 46 and the contacts leads 41), or each powered with its own power source (not shown in the Figures).

For the avoidance of any doubt as well, the above described teachings need not expressly be used in an aerosol provision system 1 which comprises a cartridge 2 and a control unit 4 separable from the cartridge 2. In that respect the teachings herein described, in accordance with some embodiments, may be employed in an aerosol provision system 1 where the reservoir 31; vaporizer 40; wick 42 and the control circuitry 18 are all located together, such as all located in a single housing.

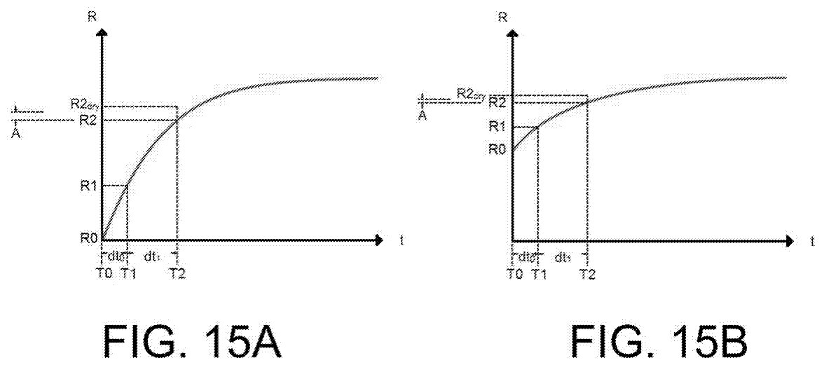

With reference to FIGS. 15A-15B, there is shown schematic charts illustrating the resistance of a heating element from an aerosol provision system changing over time and during a heating operation, which may have applications in accordance with some of the embodiments of aerosol provision system 1 described herein, such as (but not limited to) any of the embodiments described with reference to FIGS. 1-6B.

Starting with the chart shown in FIG. 15A, there is shown a plot of the resistance of the heating element 40 varying with time, and specifically varying throughout the duration of a heating operation for the heating element 40, during which time power may be supplied to the heating element 40 from the aerosol provision system 1, such as via the power supply 16 in accordance with some embodiments.

The left hand side of FIG. 15A corresponds to the initial resistance R0 of the heating element 40 when power is first provided to the heating element for the heating operation at time TO. As power is provided to the heating element 40, this causes the temperature of the heating element 40, and consequentially the resistance of the heating element 40 to also increase, noting the temperature of the heating element 40 is directly related to its resistance.

Balancing the above temperature (and thus resistance) rise of the heating element 40 is the cooling effect caused by aerosolizable material around the heating element 40 which the heating element 40 is configured to vaporize in use. In accordance with some embodiments, such as those shown in FIG. 1-6B, the aerosolizable material may be provided from the reservoir 31 for holding the aerosolizable material. In some particular embodiments thereof, a wick 42 may also be provided which is configured to receive the aerosolizable material from the reservoir 31, such that the heating element 40 is configured to vaporize the aerosolizable material received in the wick 42. However the aerosolizable material is configured to be supplied to the heating element 40, as noted previously, the aerosolizable material is configured to provide a cooling effect on the heating element 40, which thus impacts the temperature/resistance exhibited by the heating element 40 during its heating operation.

Conscious of the above, in instances where the aerosolizable material from the aerosol provisions system 1 starts to become depleted, and/or is blocked from reaching the heating element 40, this will cause the temperature, and thus the resistance, of the heating element 40 for a given point in time during the heating operation to increase at a faster rate. That being the case, where a resistance value for the heating element 40 is determined as being uncharacteristically high at a given time in the heating operation, this may be indicative of a shortage in aerosolizable material (i.e. dry-out conditions), or more fundamentally may be indicative of a fault condition in the aerosol provision system 1.

For any given heating operation, it has also to be considered that the starting temperature/resistance of the heating element 40 will also be dependent on when the heating element 40 was last subjected to a previous heating operation. In that respect therefore, and with reference to FIG. 15B, there is shown a plot of the resistance of the heating element 40 varying with time, but in conditions whereby the heating element 40 was subjected to a previous heating operation shortly before the start of the heating operation shown in FIG. 15B. The effects of this previous heating operation are visible in FIG. 15B, by virtue of the initial resistance R0 of the heating element 40 (which is the resistance when power is first provided to the heating element for the heating operation at time TO) from FIG. 15B being higher than that of the initial resistance R0 from FIG. 15A, which corresponds to a heating operation where the heating element 40 has not been subjected to a previous heating operation for a greater period of time than in FIG. 15B. Accordingly, in conditions whereby the heating element 40 is subjected to a previous heating operation shortly before the start of the heating operation, this may cause the heating element 40 to still be partially hot from the previous heating operation, and hence exhibit a higher initial resistance R0.

With the above in mind, and in accordance with some embodiments of the aerosol provision system 1 described herein, there may by provided an aerosol provision system 1 comprising: a heating element 40 for generating a vapour from an aerosolizable material; and control circuitry 18 configured to provide power for the heating element 40 for performing a heating operation to generate the vapour. In such embodiments, the control circuitry 18 may be configured for use in detecting a fault condition. In that respect, the control circuitry 18 may be configured to establish a first resistance value R1 for the resistance of the heating element 40 at a first predetermined time T1 during the heating operation; and establish a second resistance value R2 for the heating element 40 at a second predetermined time T2, after the first predetermined time T1, during the heating operation. The control circuitry 18 may be then configured to compare the second resistance value R2 with an expected resistance value, wherein the expected resistance value is higher than, and based on, the first resistance value R1; and detect a fault condition in the event the second resistance value R2 exceeds the expected resistance value by a predetermined amount A, wherein the predetermined amount A decreases as the first resistance value R1 increases.

To place the above in context, reference is initially made to FIG. 15A. In this chart, it is assumed that the heating element 40 is supplied with an adequate/predetermined amount of aerosolizable material, or put differently where the heating element 40 is saturated with aerosolizable material. In some embodiments where a wick 42 is present, the conditions from FIG. 15A may also correspond to those where the wick 42 is similarly saturated with aerosolizable material.

Contrastingly, in instances where the heating element 40 is supplied with an inadequate/unsaturated amount of aerosolizable material-herein after referred to as a dry-out condition and/or a fault condition, and/or in conditions where the wick 42 (where present) is no longer saturated with aerosolizable material, the resistance of the heating element 40 will increase at a faster rate during the initial stages of the heating operation, by virtue of there being less of a cooling effect caused by the aerosolizable material. In other words, at the second predetermined period of time T2, a higher resistance value R2_{dry} would be expected in a dry-out condition, as highlighted in FIG. 15A, compared with the resistance value R2 in a non dry-out condition.

Conscious of the above, in circumstances where the heating element 40 is adequately supplied with aerosolizable material in a non dry-out condition, e.g. as per the resistance plot in FIG. 15A, an expected resistance value would be expected at the second predetermined period of time T2. In FIG. 15A, this expected resistance value corresponds to R2. However, in the event the second resistance value R2 exceeds the expected resistance value by at least a predetermined amount A, e.g. in instances where the second resistance value is determined as being R2_{dry}, this may correspond to a dry-out condition and/or a fault condition, for the reasons described above.

In terms of the extent of the predetermined amount A, importantly this will depend on the initial resistance R0 of the heating element 40, as can be seen from FIG. 15B. In this instance, whereby the heating element 40 is subjected to a previous heating operation shortly before the start of the heating operation, such that the initial resistance R0 is higher, one would still expect a higher resistance value R2_{dry} in a dry-out condition at the second predetermined period of time T2, compared with the resistance value R2 at the second predetermined period of time T2 where the heating element 40 (or wick 42, where present) is saturated with aerosolizable material. However, in these instances of FIG. 15B, the difference in resistance between R2_{dry} and R2 at the second predetermined period of time T2 would be less than the equivalent difference in resistance between R2_{dry} and R2 at the second predetermined period of time T2 as in FIG. 15A. This is because of the higher initial resistance R0 in FIG. 15B, compared with FIG. 15A. Put differently, it can be seen that as the initial resistance R0 increases, the difference between R2_{dry} and R2 decreases at the second predetermined period of time T2. From the foregoing therefore, the control circuitry 18 is configured to compare the second resistance value R2; R2_{dry} from the second predetermined period of time T2 with an expected resistance value-corresponding to what one would expect the second resistance value to be in saturated conditions (i.e. R2 as shown in FIG. 15A or 15B) at the second predetermined period of time T2. In the event the second resistance value R2; R2_{dry} exceeds the expected resistance value by at least a predetermined amount A, this may be indicative of a fault/dry-out condition. Importantly as well, to compensate for different initial resistances R0 in the heating element, depending on when the heating element 40 was used recently, the predetermined amount A decreases as the initial resistance value R0 increases (and/or, by extension, as the first resistance value R1 increases), as can be seen in FIGS. 15A-15B.

In terms of when the second predetermined time T2 may occur during the heating operation, in accordance with some embodiments, the second predetermined time T2 may occur during the period when the heating element is still heating up, and towards the start of the heating operation where the biggest changes in resistance/temperature in the heating element 40 an be observed. In accordance with some embodiments, the second predetermined time T2 may immediately follow a first predetermined time interval dt₁ starting from the first predetermined period of time T1.

In that respect as well, the first predetermined period of time T1 could correspond to the time TO when power is first provided to the heating element for the heating operation, or could correspond to the time immediately following an initial predetermined time interval dt₀ starting from the time TO when power is first provided to the heating element for the heating operation, as may be required. In that respect therefore, the first resistance value R1 will be directly related to, if not be the same as, the value of the initial resistance value R0—depending on the time interval selected for the initial predetermined time interval dt₀.

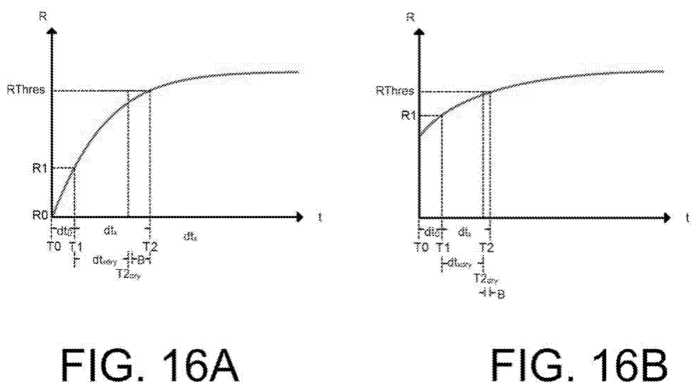

Moving away from the disclosure of FIGS. 15A-15B, another equally viable configuration for detecting a fault/dry-out condition in the aerosol provision system 1 described herein can be seen with reference to FIGS. 16A-16B. In accordance with such embodiments, rather than comparing the second resistance value R2 after a particular/fixed second predetermined period of time T2, in the embodiments relating to FIGS. 16A-16B, the control circuitry 18 may be configured to establish the time taken dtₓ, from the first predetermined time T1, for the heating element 40 to reach a predetermined resistance value R_{Thres} during the heating operation. In such embodiments, the predetermined resistance value R_{Thres} is larger than the first resistance value R1, and the control circuitry 18 is configured to compare the time taken dtₓ with an expected time taken, wherein the expected time taken is based on the first resistance value R1, and corresponds to the time taken in a condition when the heating element 40 is saturated with aerosolizable material (i.e. not in a dry-out condition).

From there, the control circuitry 18 is then configured to detect a fault/dry-out condition in the event the time taken dtₓ is less than the expected time taken by at least a predetermined amount B, wherein the predetermined amount B decreases as the first resistance value R1 increases.

To place the above in context, reference is initially made to FIG. 16A. In this chart, it is assumed that the heating element 40 is saturated with aerosolizable material. In some embodiments where a wick 42 is present, the conditions from FIG. 16A may correspond to those where the wick 42 is similarly saturated with aerosolizable material.

Contrastingly, in a dry-out condition, the resistance of the heating element 40 would increase at a faster rate during the initial stages of the heating operation, by virtue of there being less of a cooling effect caused by the aerosolizable material in the vicinity of the heating element 40. Conscious of the above, by setting a fixed/predetermined resistance value R_{Thres}, the time T_{2dry} (and corresponding time taken dt_{xdry}) at which R_{Thres} is reached will be shorter in a dry-out condition, compared with the corresponding time T₂ (and corresponding time taken dtₓ) at which R_{Thres} is reached in a situation when the heating element 40 (and/or wick 42, where present) is saturated with aerosolizable material.

With respect to the first predetermined period of time T1, and the corresponding time taken dtₓ from the first predetermined time T1, it will be appreciated (as noted previously) that the first predetermined period of time T1 could correspond to the time TO when power is first provided to the heating element for the heating operation, or could correspond to the time immediately following an initial predetermined time interval dt₀ starting from the time TO when power is first provided to the heating element 40 for the heating operation, as may be required.

Whatever the selected first predetermined period of time T1 (and its corresponding first resistance value R1), it is to be noted that the predetermined amount B corresponding to the predetermined resistance value R_{Thres} will depend on the initial resistance R0 of the heating element 40, as can be seen from FIG. 16B.

In this instance from FIG. 16B, where the heating element 40 is subjected to a previous heating operation shortly before the start of the heating operation, the time taken dt_{xdry} to reach the predetermined resistance value R_{Thres} in a dry-out condition will be less than the corresponding time taken dtₓ to reach the predetermined resistance value R_{Thres} when the heating element 40 is saturated with aerosolizable material (as is also the case in FIG. 16A).

That being said, the difference in time taken between dt_{xdry} and dtₓ from FIG. 16B would be less than the equivalent difference in time taken between dt_{xdry} and dtₓ as in FIG. 16A. This is because of the higher initial resistance R0 in FIG. 16B, compared with FIG. 16A. Put differently, as the initial resistance R0 (and/or commensurately as the first resistance value R1 increases), the difference in the time taken between dt_{xdry} and dtₓ decreases. Accordingly, as the initial resistance R0 and/or the first resistance value R1 increases, the predetermined amount B decreases. In this way, the predetermined amount B can factor the fault condition being appropriately detected by the control circuitry 18, irrespective of when the heating element 40 was subject to a previous heating operation, and hence irrespective of the starting temperature/resistance of the heating element 40 at the start of a given heating operation.

From the foregoing therefore, the control circuitry 18 in accordance with some embodiments, such as those relating FIGS. 16A-16B is configured to establish the time taken dtₓ, from the first predetermined time T1, for the heating element 40 to reach the predetermined resistance value R_{Thres} during a given heating operation. From there, the control circuitry 18 is then configured to compare the time taken dtₓ, with an expected time taken for the heating element 40 to reach the predetermined resistance value R_{Thres}, wherein the expected time taken is based on the first resistance value R1, and from there detect a fault condition in the event the time taken is less than the expected time taken by at least a predetermined amount B, wherein the predetermined amount B decreases as the first resistance value R1 (and/or, by extension, as the corresponding initial resistance value R0) increases.

With regard to the duration of the expected time taken, it is envisaged that this would correspond to the time taken for the heating element 40 to reach the predetermined resistance value R_{Thres} from the first resistance value R1 in conditions when the heating element 40 is saturated with aerosolizable material. In that respect, in the particular arrangements of FIGS. 16A and 16B, the indicated time taken dtₓ in these arrangements would correspond to the expected time taken.

Irrespective of the functionality employed by the control circuitry 18 for detecting a fault/dry-out condition in the aerosol provision system 1, it is envisaged that in response to detecting such a fault condition, in some embodiments the control circuitry 18 may be configured to take action in response thereto. In that respect, and in accordance with some embodiments, in response to detecting the fault condition, the control circuitry 18 may be further configured to disable the operation of the aerosol provision system 1 and/or disable the operation of the heating element 40. In this way, such disabling may allow the heating element 40 sufficient time to cool down, and/or may allow for the aerosol provision system 1 to be replenished with more aerosolizable material.

In embodiments where the operation of the aerosol provision system 1 and/or the operation of the heating element 40 are disabled, in accordance with some particular embodiments thereof, the operation may be permanently disabled and/or disabled until the control circuitry 18 determines that the aerosolizable material in the aerosol provision system 1 has been replenished.

In accordance with some particular embodiments where the aerosol provision system comprises the cartridge 2 and the control unit 4, in some particular embodiments thereof, in response to detecting the fault condition, the control circuitry 18 may be configured to disable operation of the aerosol provision system 1 until the control circuitry 18 determines that a different cartridge 2 has been coupled to the control unit 4.

In accordance with some embodiments, in response to the fault detection the control circuitry 18 may be further configured to generate an output signal for providing a notification to a user. In respect of the output signal which is generated in the above instances, in accordance with some embodiments, the signal may be at least one of: an optical signal, an acoustic signal, and a haptic signal, which can be used to provide an indication to the user. Such an indication, in accordance with some particular embodiments, may include any of: an indication to the user that the aerosolizable material requires refilling; that the cartridge 2 requires replacing (where a cartridge 2/control unit 4 arrangement is employed); and/or an indication to the user that at least a portion of the aerosol provision system 1 has overheated.

To implement the above indications, as required, in accordance with some embodiments, the aerosol provision system 1 may further comprise any one or combination of an optic element (such as an LED), an acoustic element (such as a speaker) and a haptic feedback element (such as a vibrator). Appreciably, in some particular embodiments to those set out above, any such optical/acoustic/haptic feedback element(s) may be most conveniently located on the control unit 4 (where such a cartridge 2/control unit 4 arrangement is employed).

Turning to how the control circuitry 18 may be configured to establish each resistance value of the heating element 40, it is envisaged that this may be achieved in a number of different ways. In that respect, and in accordance with some embodiments, the control circuitry 18 may be configured to monitor the resistance of the heating element 40 to determine each required resistance value, such as the first resistance value R1; the second resistance value R2; and/or the predetermined resistance value R_{Thres}.

In accordance with some embodiments, the aerosol provision system 1 may further comprise a sensor, wherein the sensor is configured to output at least one sensor signal containing data related to the temperature of the heating element 40. In such embodiments, the control circuitry 18 may be then further configured to receive the at least one sensor signal to establish each resistance value (such as the first resistance value R1; the second resistance value R2; and/or the predetermined resistance value R_{Thres}) of the heating element 40. In that respect, and in accordance with a particular embodiment thereof, the sensor may be configured to output a first sensor signal containing data related to the temperature of the heating element 40; wherein the control circuitry 18 is configured to receive the first sensor signal to establish the first resistance value from the data from the first sensor signal. In a similar vein, and in accordance with some embodiments such as those relating to FIGS. 15A-15B, the sensor may be further configured to output a second sensor signal containing data related to the temperature of the heating element 40, and wherein the control circuitry 18 is configured to receive the second sensor signal to establish the second resistance value R2 and/or the predetermined resistance value R_{Thres} from the data from the second sensor signal.

Where any sensor (such as a thermometer or other resistive temperature sensor) is employed in the aerosol provision system 1 to output a sensor signal(s) containing data related to the temperature of the heating element 40, it will be appreciated that this sensor may be powered, as required, using either the power supply 16 (as shown in the embodiment of FIG. 1-6B), or powered with its own power source (not shown in the Figures).

Also in respect of any such sensor in the aerosol provision system 1, it will be appreciated that any signal therefrom may be sent using a wired or wireless connection between the control circuitry 18 and the sensor. In that respect, where a wired connection is provided between the sensor and the control circuitry 18, this may extend in the case of the sensor being located in the cartridge 2 across the interface end 54 and corresponding receptacle 8 between the control unit 4 and the cartridge 2 via the contact electrodes 46.

Appreciably, the techniques employed to detect a fault condition in an aerosol provision system may be used in a wide variety of such systems. In that respect, and in accordance with some embodiments, beyond the provided heating element 40 and the control circuitry 18, the aerosol provision system may further comprise a reservoir 31 for holding the aerosolizable material, and may in some particular embodiments thereof further comprise a wick 42 configured to receive the aerosolizable material from the reservoir, wherein the heating element 40 is configured to vaporize the aerosolizable material received in the wick 42.

The techniques herein described to detect a fault condition in the aerosol provision system 1 may notably be employed in an aerosol provision system 1 which comprises a cartridge 2 and a control unit 4, such as any of the arrangements shown in FIGS. 1-6B. In such embodiments, the reservoir 31 and the heating element 40 may be located in the cartridge 2, and the control unit 4 may comprise a cartridge receiving section 8 that includes an interface arranged to cooperatively engage with the cartridge 2 so as to releasably couple the cartridge 2 to the control unit 4, wherein the control unit 4 further comprises the power supply 16 and the control circuitry 18. That being said, and for the avoidance of any doubt, the techniques herein described for detecting a fault condition in an aerosol provision system 1 need not expressly be used in an aerosol provision system 1 which comprises a cartridge 2 and a control unit 4 separable from the cartridge 2.

From the above described techniques therefore, and with reference to FIGS. 15A-15B, there is consequentially and similarly provide a method of detecting a fault condition in an aerosol provision system 1, wherein the aerosol provision system 1 further comprises control circuitry 18, and wherein the method comprises the control circuitry 18: providing power to a heating element 40 for performing a heating operation to generate vapour from an aerosolizable material; establishing a first resistance value R1 for the resistance of the heating element 40 at a first predetermined time T1 during the heating operation; establishing a second resistance value R2 for the heating element at a second predetermined time T₂, after the first predetermined time T1, during the heating operation; comparing the second resistance value R2 with an expected resistance value, wherein the expected resistance value is higher than, and based on, the first resistance value R1; and detecting a fault condition in the event the second resistance value R2 exceeds the expected resistance value by a predetermined amount A, wherein the predetermined amount A decreases as the first resistance R1 value increases.

The above described techniques, with reference to FIGS. 16A-16B, also consequentially and similarly provide a method of detecting a fault condition in an aerosol provision system 1, wherein the aerosol provision system further comprises control circuitry 18, and wherein the method comprises the control circuitry 18: providing power to a heating element 40 for performing a heating operation to generate vapour from an aerosolizable material; establishing a first resistance value R1 for the resistance of the heating element 40 at a first predetermined time T1 during the heating operation; establishing the time taken dtₓ, from the first predetermined time T1, for the heating element 40 to reach a predetermined resistance value R_{Thres} during the heating operation, wherein the predetermined resistance value R_{Thres} is larger than the first resistance value R1; comparing the time taken dtₓ with an expected time taken, wherein the expected time taken is based on the first resistance value R1; and detecting a fault condition in the event the time taken dtₓ is less than the expected time taken by at least a predetermined amount B, wherein the predetermined amount B decreases as the first resistance value R1 increases.

Thus in accordance with certain embodiments of the disclosure, a cartridge for an aerosol provision system may generally comprise a housing part having a mouthpiece end and an interface end, wherein the mouthpiece end includes an aerosol outlet for the cartridge and the interface end includes an interface for coupling the cartridge to a control unit. An air channel wall (which may be formed by various components of the cartridge) extends from an air inlet for the cartridge to the aerosol outlet via an aerosol generation region in the vicinity of a vaporizer. The cartridge has a reservoir within the housing part containing aerosolizable material for aerosolisation. The reservoir is defined by a region within the housing part which is outside the air channel and an end of the reservoir at the interface end of the housing part is sealed by a resilient plug comprising a base part and an outer wall, wherein the outer wall of the resilient plug forms a seal with an inner surface of the housing part. Respective ends of a aerosolizable material transport element pass through opening in the air channel or into the reservoir so as to convey aerosolizable material from the reservoir to the vaporizer.

One aspect of some particular cartridge configurations in accordance with certain embodiments of the disclosure is the manner in which the resilient plug 44 provides a seal to the housing part 32. In particular, in accordance with some example implementations the outer wall 102 of the resilient plug 44 which seals to the inner surface of the housing part 32 to form the end of the aerosolizable material reservoir extends in direction parallel to the longitudinal axis of the cartridge to a position which is further from the interface end of the cartridge than the aerosolizable material transport element/vaporizer. That is to say, the ends of the aerosolizable material transport element extends into the aerosolizable material reservoir in a region which is surrounded by the outer sealing wall of the resilient plug. Not only does this help seal the reservoir against leakage, it allows the geometry of the reservoir in the region which supplies the aerosolizable material transport element with aerosolizable material to be governed by the geometry of the resilient plug. For example, the radial thickness of the reservoir in this region can readily be made smaller than the radial thickness in other longitudinal positions along the air channel, which can help trap aerosolizable material in the vicinity of the aerosolizable material transport element, thereby helping to reduce the risk of dry out for different orientations of the cartridge during use.

The outer wall of the resilient plug may, for example, contact the inner surface of the housing part at locations over a distance of at least 5 mm, 6 mm, 7 mm, 8 mm, 9 mm and 10 mm in a direction extending from the interface end to the mouthpiece end (i.e. parallel to the longitudinal axis). The outer wall of the resilient plug may be in contact with the inner surface of the housing over the majority of this distance, or the outer wall of the resilient plug may include a number of (e.g. four) circumferential ridges 140 to help improve sealing. The resilient plug may be slightly oversized relative to the opening in the housing part so that it is biased into slight compression. For example, for the implementation shown in FIG. 3B, the interior width of the housing part into which the resilient plug is inserted in the plane of this figure is around 17.5 mm, whereas the corresponding width of the resilient plug is around 18 mm, thereby placing the resilient plug into compression when inserted into the housing part. As can be most readily seen in FIGS. 5A to 5C, whereas the outer cross section of the cartridge housing part is symmetric under a 180° rotation, the resilient plug 44 does not have the same symmetry because it includes a flat 142 on one side to accommodate the air channel gap 76 provided by the double-walled section 74 of the housing part (i.e. the resilient plug is asymmetric in a plane perpendicular to a longitudinal axis of the cartridge to accommodate the double-walled section of the housing part).

In terms of the radial size/width of the reservoir in the annular region where the aerosolizable material transport element extends into the reservoir, a distance between the air channel wall and the outer wall of the resilient plug in this region may, for example, be in the range 3 mm to 8 mm. In the example cartridge discussed above which has a generally oval housing part and a generally circular air channel, it will be appreciated the thickness of the reservoir is different at different locations around the air channel. In this example the aerosolizable material transport element is arranged to extend into the reservoir in the region where it is widest in the axial direction, i.e. into the “lobes” of the oval reservoir around the air channel. The portions of the aerosolizable material transport element that extend into the reservoir may, for example, have a length, as measured from the interior of the air channel wall, in the range 2 mm to 8 mm, e.g. in the range 3 mm to 7 mm or in the range 4 mm to 6 mm. The specific geometry in this regard (and for other aspects of the configuration) may be chosen having regard to a desired rate of aerosolizable material transport, for example having regard to the capillary strength of the aerosolizable material transport element and the viscosity of the aerosolizable material, and may be established for a given cartridge design through modelling or empirical testing.

Another aspect of some particular cartridge configurations in accordance with certain embodiments of the disclosure is the manner in which the air channel is routed through the cartridge, and in particular from the air inlet to the vicinity of the vaporizer (the aerosol generation region). In particular, whereas in a conventional cartridges an air inlet is typically provided at the interface end of the cartridge, in accordance with certain embodiments of the disclosure, an air inlet for the cartridge is located in a side wall of the housing part at a position which is further from the interface end than at least a part of the resilient plug that seals an end of the reservoir. Thus, the air channel in the cartridge is initially routed from the air inlet towards the interface end and bypasses the resilient plug before changing direction and entering the aerosol generation chamber through the resilient plug. This can allow the outer surface of the cartridge at the interface end, where it is closest to the vaporizer, to be closed, thereby helping to reduce the risk of leakage from the cartridge, both in terms of aerosolizable material coming through the openings in the air channel which is not retained by the aerosolizable material transport element in the air channel (e.g. due to saturation/agitation) or aerosolizable material that has being vaporized but condensed back to aerosolizable material in the air channel during use. In some implementations, a distance from air inlet to the interface end of the housing part may be at least 5 mm, 6 mm, 7 mm, 8 mm, 9 mm or 10 mm.

In some example implementations an absorbent element, for example a portion of sponge material or a series of channels forming a capillary trap, may be provided between the air inlet and the aerosol generation chamber, for example in the region air channel formed between the base of the resilient plug and the end cap, to further help reduce the risk of leakage by absorbing aerosolizable material that forms in the air channel and so helping prevent the aerosolizable material travelling around the air channel through the air inlet or towards the aerosol outlet.

In some example implementations the air channel from the air inlet to the aerosol outlet may have its smallest cross-sectional area where it passes through the hole 106 in the resilient plug. That is to say, the hole in the resilient plug may be primarily responsible for governing the overall resistance to draw for the electronic cigarette.

Another aspect of some particular cartridge configurations in accordance with certain embodiments of the disclosure is the manner in which the dividing wall element divides the air reservoir into two regions, namely a main region above the dividing wall (i.e. towards a mouthpiece end of the cartridge) and a aerosolizable-material-supply region below the dividing wall (i.e. on the same side of the dividing wall as where the aerosolizable material transport element extends from the vaporizer into the reservoir). The dividing wall includes openings to govern the flow of aerosolizable material on the main region to the aerosolizable material supply region. The dividing wall can help retain aerosolizable material in the aerosolizable material supply region of the reservoir, example when the electronic cigarette is tilted through various orientations, which can help avoid dry out. The dividing wall can also conveniently provide a mechanical stop for the resilient plug to abut/press against so as to help correctly locate the resilient plug during assembly and maintain the resilient plug in slight compression between the dividing wall and the end cap when the cartridge is assembled.

In the example discussed above, the dividing wall is formed as a separate element form the housing part, wherein an inner surface of the housing part includes one or more protrusions arranged to contact the side of the dividing wall facing the mouthpiece end of the cartridge to locate the dividing wall along a longitudinal axis of the cartridge, but in other examples the dividing wall may be integrally formed with the housing part.

In the example discussed above the dividing wall is in the form of an annular band around the air channel and comprises four fluid communication openings 150 located in respective quadrants of the band. However, more or fewer openings through the dividing wall may be provided in different implementations. Individual openings may, for example, have an area of between 4 mm² and 15 mm².

A combined area for the at least one openings as a fraction of the total area of the dividing wall exposed to aerosolizable material supply region of the reservoir region may be, for example, from 20% to 80%; 30% to 70% or 40% to 60%.

It will be appreciated that while the above description has focused on some specific cartridge configurations comprising a number of different features, cartridges in accordance with other embodiments of the disclosure may not include all these features. For example, in some implementations an air path generally of the kind discussed above, i.e. with an air inlet which is in a sidewall of the cartridge and closer to the mouthpiece end of the cartridge than the vaporizer, may be provided in a cartridge which does not include a resilient plug with an outer sealing wall which extends around the vaporizer and/or does not include a dividing wall element of the kind discussed above. Similarly, a cartridge which does include a resilient plug with an outer sealing wall which extends around the vaporizer may have an air inlet into the cartridge which is at the interface end of the cartridge, and not in a sidewall, and which may also not have a dividing wall element of the kind discussed above. Furthermore, a cartridge which does include a dividing wall element, might not include an air inlet located further from the interface end of the cartridge than the vaporizer and/or an extended outer sealing wall for a resilient plug as discussed above.

Thus, there has been described an aerosol provision system comprising:
a reservoir for aerosolizable material;
a vaporizer for vaporising aerosolizable material from the reservoir;
a sensor system, separate from the vaporizer, for detecting the temperature of the vaporizer, wherein the sensor system comprises a first resistor.

There has also been described a cartridge for an aerosol provision system comprising the cartridge and a control unit, wherein the cartridge comprises:
a reservoir for aerosolizable material;
a vaporizer for vaporising aerosolizable material from the reservoir; and
a sensor system, separate from the vaporizer, for detecting the temperature of the vaporizer, wherein the sensor system comprises a first resistor.

There has also been described an aerosol provision system 1 comprising a reservoir 31 for aerosolizable material; a vaporizer 40 for vaporising aerosolizable material from the reservoir 31; and a sensor system 500, separate from the vaporizer 40, for detecting the temperature of the vaporizer 40, wherein the sensor system 500 comprises a first resistor 502. The sensor system 500 may also comprise a second resistor 504. Each resistor 502;504 may be located on a wick 42 from the aerosol provision system 1, along with the vaporizer 40. The sensor system 500 may be separate from the vaporizer 40, in so far as each resistor 502;504 from the sensor system may be physically spaced from the vaporizer 40, and in so far as determining the temperature of the vaporizer 40 may be determined off data from the sensor system 500, as opposed to off any data from the vaporizer 40 itself.

There has also been described an aerosol provision system comprising:
a reservoir for aerosolizable material;
a vaporizer for vaporising aerosolizable material from the reservoir;
a sensor system, separate from the vaporizer, for determining the temperature of the vaporizer, wherein the sensor system comprises a capacitor and an inductor.

There has also been described a cartridge for an aerosol provision system comprising the cartridge and a control unit, wherein the cartridge comprises:
a reservoir for aerosolizable material;
a vaporizer for vaporising aerosolizable material from the reservoir; and
a sensor system, separate from the vaporizer, for determining the temperature of the vaporizer, wherein the sensor system comprises a capacitor and an inductor.

There has also been described an aerosol provision system 1 comprising a reservoir 31 for aerosolizable material; a vaporizer 40 for vaporising aerosolizable material from the reservoir 31; and a sensor system 500, separate from the vaporizer 40, for determining the temperature of the vaporizer 40. The sensor system 500 comprises a capacitor 502 and an inductor 504. The sensor system 500 may be separate from the vaporizer 40, in so far as the capacitor 502 and the inductor 504 may be physically spaced from the vaporizer 40, and in so far as determining the temperature of the vaporizer 40 may be determined off data from the sensor system 500, as opposed to off any data from the vaporizer 40 itself.

There has also been described an aerosol provision system comprising:
a reservoir for aerosolizable material;
a wick configured to receive the aerosolizable material from the reservoir;
a vaporizer for vaporising aerosolizable material in the wick; and
control circuitry, wherein the control circuitry is configured to:
   determine a first parameter relating to a temperature of the vaporizer;
   determine a second parameter relating to a temperature of the wick; and
   generate an output signal based on a comparison between the first parameter and the second parameter.

There has also been described a method of monitoring temperatures in an aerosol provision system comprising a reservoir for aerosolizable material, a wick configured to receive the aerosolizable material from the reservoir, and a vaporizer for vaporising aerosolizable material in the wick, wherein the method comprises control circuitry from the aerosol provision system: determining a first parameter relating to a temperature of the vaporizer;
determining a second parameter relating to a temperature of the wick;
performing a comparison between the first parameter and the second parameter; and
generating an output signal based on the comparison.

There has also been described an aerosol provision system 1 comprising a reservoir 31 for aerosolizable material; a wick 42 configured to receive the aerosolizable material from the reservoir 31; a vaporizer 40 for vaporising aerosolizable material in the wick 42; and control circuitry 18. The control circuitry 18 is configured to determine a first parameter relating to a temperature of the vaporizer 40; determine a second parameter relating to a temperature of the wick 42; and generate an output signal based on a comparison between the first parameter and the second parameter. This functionality of the control unit 18 may allow it to better detect defects relating to the wick 42; or the aerosol provision system 1 starting to dry out.

There has also been described an aerosol provision system comprising:
a heating element for generating a vapour from an aerosolizable material; and
control circuitry configured to provide power for the heating element for performing a heating operation to generate the vapour, and configured for use in detecting a fault condition, wherein the control circuitry is configured to:
establish a first resistance value for the resistance of the heating element at a first predetermined time during the heating operation; and
establish a second resistance value for the heating element at a second predetermined time, after the first predetermined time, during the heating operation;
compare the second resistance value with an expected resistance value, wherein the expected resistance value is higher than, and based on, the first resistance value; and
detect a fault condition in the event the second resistance value exceeds the expected resistance value by a predetermined amount, wherein the predetermined amount decreases as the first resistance value increases.

There has also been described an aerosol provision system comprising:
a heating element for generating a vapour from an aerosolizable material; and
control circuitry configured to provide power for the heating element for performing a heating operation to generate the vapour, and configured for use in detecting a fault condition, wherein the control circuitry is configured to:
establish a first resistance value for the resistance of the heating element at a first predetermined time during the heating operation;
establish the time taken, from the first predetermined time, for the heating element to reach a predetermined resistance value during the heating operation, wherein the predetermined resistance value is larger than the first resistance value;
compare the time taken with an expected time taken, wherein the expected time taken is based on the first resistance value; and
detect a fault condition in the event the time taken is less than the expected time taken by at least a predetermined amount, wherein the predetermined amount decreases as the first resistance value increases.

There has also been described a method of detecting a fault condition in an aerosol provision system, wherein the aerosol provision system further comprises control circuitry, and wherein the method comprises the control circuitry:
providing power to a heating element for performing a heating operation to generate vapour from an aerosolizable material;
establishing a first resistance value for the resistance of the heating element at a first predetermined time during the heating operation;
establishing a second resistance value for the heating element at a second predetermined time, after the first predetermined time, during the heating operation;
comparing the second resistance value with an expected resistance value, wherein the expected resistance value is higher than, and based on, the first resistance value; and
detecting a fault condition in the event the second resistance value exceeds the expected resistance value by a predetermined amount, wherein the predetermined amount decreases as the first resistance value increases.

There has also been described a method of detecting a fault condition in an aerosol provision system, wherein the aerosol provision system further comprises control circuitry, and wherein the method comprises the control circuitry:
providing power to a heating element for performing a heating operation to generate vapour from an aerosolizable material;
establishing a first resistance value for the resistance of the heating element at a first predetermined time during the heating operation; and
establishing the time taken, from the first predetermined time, for the heating element to reach a predetermined resistance value during the heating operation, wherein the predetermined resistance value is larger than the first resistance value;
comparing the time taken with an expected time taken, wherein the expected time taken is based on the first resistance value; and
detecting a fault condition in the event the time taken is less than the expected time taken by at least a predetermined amount, wherein the predetermined amount decreases as the first resistance value increases.

There has also been described an aerosol provision system 1 comprising a heating element 40 for generating a vapour from an aerosolizable material; and control circuitry 18 configured to provide power for the heating element 40 for performing a heating operation to generate the vapour. The control circuitry 18 is configured to compare a resistance change in the heating element 40 in a predetermined interval during a heating operation of the heating element 40, with an expected resistance change for the heating element 40 in the predetermined interval, and then detect a fault condition in the event the resistance change from the predetermined interval deviates from, and/or is outside a predetermined expected resistance change for the heating element in the predetermined interval.

While the above described embodiments have in some respects focused on some specific example aerosol provision systems, it will be appreciated the same principles can be applied for aerosol provision systems using other technologies. That is to say, the specific manner in which various aspects of the aerosol provision system function, for example in terms of the underlying form of the vaporizer or vaporizer technology used are not directly relevant to the principles underlying the examples described herein.

In that respect, it will also be appreciated that various modifications may be made to the embodiments of aerosol provision system described herein. For instance, although the vaporizer 40 has been described in a number of the above embodiments as being located in the cartridge, it will be appreciated that in some embodiments the vaporizer may be located in the control unit of the aerosol provision system.

In order to address various issues and advance the art, this disclosure shows by way of illustration various embodiments in which the claimed invention(s) may be practiced. The advantages and features of the disclosure are of a representative sample of embodiments only, and are not exhaustive and/or exclusive. They are presented only to assist in understanding and to teach the claimed invention(s). It is to be understood that advantages, embodiments, examples, functions, features, structures, and/or other aspects of the disclosure are not to be considered limitations on the disclosure as defined by the claims or limitations on equivalents to the claims, and that other embodiments may be utilised and modifications may be made without departing from the scope of the claims. Various embodiments may suitably comprise, consist of, or consist essentially of, various combinations of the disclosed elements, components, features, parts, steps, means, etc. other than those specifically described herein, and it will thus be appreciated that features of the dependent claims or clauses may be combined with features of the independent claims or independent clauses in combinations other than those explicitly set out in the claims and clauses. The disclosure may include other inventions not presently claimed, but which may be claimed in future. In effect, any combination of feature(s) from one set of claims may be combined with any other individual feature(s) from any of the remaining set of claims or clauses.

### First Set of Clauses

1. An aerosol provision system comprising:
a reservoir for aerosolizable material;
a vaporizer for vaporising aerosolizable material from the reservoir;
a sensor system, separate from the vaporizer, for determining the temperature of the vaporizer, wherein the sensor system comprises a capacitor and an inductor.
   2. The aerosol provision system of clause 1, wherein the sensor system is configured to:
determine a capacitance value of the capacitor;
determine an inductance value of the inductor; and
process the capacitance value and the inductance value to determine the temperature of the vaporizer.
   3. The aerosol provision system of any preceding clause, wherein the sensor system is configured to:
determine a resonant frequency parameter relating to the inductor and the capacitor from the sensor system; and
process the resonant frequency parameter to determine the temperature of the vaporizer.
   4. The aerosol provision system of clause 3, when further dependent on clause 2, wherein the sensor system is further configured to:
determine the resonant frequency parameter from the capacitance value and the inductance value.
   5. The aerosol provision system of clause 3 or 4, wherein the sensor system is further configured to:
match the resonant frequency parameter with one of a plurality of predetermined resonant frequency parameters stored in a look-up table, wherein each predetermined resonant frequency parameter from the look-up table comprises an associated predetermined temperature value from the look-up table;
wherein response to matching the resonant frequency parameter with one of the plurality of predetermined resonant frequency parameters, the sensor system is configured to utilise the associated predetermined temperature value for the matched predetermined resonant frequency parameter to determine the temperature of the vaporizer.
   6. The aerosol provision system of clause 5, wherein the sensor system is further configured to:
in response to not matching the resonant frequency parameter with one of a plurality of predetermined resonant frequency parameters stored in the look-up table:
   identify a first predetermined resonant frequency parameter, from the predetermined resonant frequency parameters, which is less than the resonant frequency parameter; and
   identify a second predetermined resonant frequency parameter, from the predetermined resonant frequency parameters, which is greater than the resonant frequency parameter;
interpolate between the first predetermined resonant frequency parameter and the second predetermined resonant frequency parameter, using the resonant frequency parameter, to determine an interpolated temperature value which is between the associated predetermined temperature values for the first and second predetermined resonant frequency parameters; and
utilise the interpolated temperature value to determine the temperature of the vaporizer.
   7. The aerosol provision system of any preceding clause, further comprising a first power supply configured to provide electrical power to the vaporizer.
   8. The aerosol provision system of clause 7, wherein the first power supply is configured to provide direct current to the vaporizer.
   9. The aerosol provision system of clause 7, wherein the first power supply is configured to provide alternating current to the vaporizer.
   10. The aerosol provision system of any of clauses 7-9, further comprising control circuitry configured to adjust the amount of power provided by the first power supply to the vaporizer.
   11. The aerosol provision system of clause 10, wherein the control circuitry comprises a portion of the sensor system.
   12. The aerosol provision system of clause 10 or 11, wherein the sensor system is configured to provide an output signal containing data related to the temperature of the vaporizer, wherein the control circuitry is configured to:
process the data from the output signal; and
generate, in response to processing the data from the output signal, a first control signal for controlling the operation of the first power supply.
   13. The aerosol provision system of clause 12, wherein the first control signal comprises a command to vary the amount of power provided by the first power supply to the vaporizer.
   14. The aerosol provision system of clause 13, wherein the first control signal comprises a command to stop providing power to the vaporizer from the first power supply.
   15. The aerosol provision system of any preceding clause, further comprising a second, alternating current, power supply for providing electrical power to the sensor system.
   16. The aerosol provision system of clause 15, when further dependent clause 6, wherein the second power supply is independent of the first power supply.
   17. The aerosol provision system of any of clauses 15-16, when further dependent on clause 10, wherein the control circuitry is further configured to:
generate, in response to processing the data from the output signal, a second control signal for controlling the operation of the second power supply, wherein the second control signal comprises a command to stop providing power to the sensor system from the second power supply.
   18. The aerosol provision system of any preceding clause, further comprising a wick configured to receive the aerosolizable material from the reservoir, wherein the vaporizer is configured to vaporize the aerosolizable material received in the wick.
   19. The aerosol provision system of clause 18, wherein the wick comprises a ceramic material.
   20. The aerosol provision system of clause 18 or 19, wherein the vaporizer comprises a conductive material located on an external surface of the wick.
   21. The aerosol provision system of any of clauses 18-20, wherein the capacitor and the inductor from the sensor system are located on an external surface of the wick.
   22. The aerosol provision system of any of clauses 18-21, wherein the wick comprises a fibrous material.
   23. An aerosol provision system according to any preceding clause, further comprising a cartridge and a control unit;
wherein the reservoir, the vaporizer, the capacitor and the inductor, are located in the cartridge;
wherein the control unit comprises a cartridge receiving section that includes an interface arranged to cooperatively engage with the cartridge so as to releasably couple the cartridge to the control unit.
   24. An aerosol provision system according to clause 23, when further dependent on clause 7, wherein the control unit comprises the first power supply.
   25. An aerosol provision system according to clause 23 or 24, when further dependent on clause 15, wherein the control unit comprises the second power supply.
   26. An aerosol provision system according to any of clauses 23-25, when further dependent on clause 18, wherein the wick is located in the cartridge.
   27. A cartridge for an aerosol provision system comprising the cartridge and a control unit, wherein the cartridge comprises:
a reservoir for aerosolizable material;
a vaporizer for vaporising aerosolizable material from the reservoir; and
a sensor system, separate from the vaporizer, for determining the temperature of the vaporizer, wherein the sensor system comprises a capacitor and an inductor.

### Second Set of Clauses

1. An aerosol provision system comprising:
a reservoir for aerosolizable material;
a wick configured to receive the aerosolizable material from the reservoir;
a vaporizer for vaporising aerosolizable material in the wick; and
control circuitry, wherein the control circuitry is configured to:
   determine a first parameter relating to a temperature of the vaporizer;
   determine a second parameter relating to a temperature of the wick; and
   generate an output signal based on a comparison between the first parameter and the second parameter.
      2. An aerosol provision system according to clause 1, wherein the control circuitry is further configured to measure the resistance of the vaporizer, and generate first data related to the resistance of the vaporizer;
wherein the control circuitry is further configured to process the first data to determine the first parameter.
   3. An aerosol provision system according to clause 1, wherein the aerosol provision system comprises a first temperature sensor for outputting a first signal containing first data related to the temperature of the vaporizer;
wherein the control circuitry is further configured to receive the first signal from the first sensor, and process the first data from the first signal to determine the first parameter.
   4. An aerosol provision system according to clause 3, wherein the first temperature sensor comprises a resistor.
   5. An aerosol provision system according to any preceding clause, wherein the wick comprises a second temperature sensor for outputting a second signal containing second data related to the temperature of the wick;
wherein the control circuitry is further configured to receive the second signal from the second temperature sensor, and process the second data from the second signal to determine the second parameter.
   6. An aerosol provision system according to clause 5, wherein the second temperature sensor comprises a resistor.
   7. An aerosol provision system according to clause 5 or 6, wherein the second sensor is located on an external surface of the wick.
   8. An aerosol provision system according to any preceding clause, wherein the control circuitry being configured to generate an output signal based on a comparison between the first parameter and the second parameter further comprises the control circuitry being configured to.
divide one of the first and second parameters by the other of the first and second parameters to determine a ratio; and generate the output signal in the event that the ratio falls outside a predetermined range.
   9. An aerosol provision system according to clause 8, wherein the predetermined range comprises a first predetermined value defining a lowermost end of the predetermined range.
   10. An aerosol provision system according to clause 8 or 9, wherein the predetermined range comprises a second predetermined value defining an uppermost end of the predetermined range.
   11. An aerosol provision system according to any preceding clause, wherein the output signal comprises a command to disable the operation of the aerosol provision system.
   12. An aerosol provision system according to any preceding clause, wherein the output signal comprises a command to disable the operation of the vaporizer.
   13. An aerosol provision system according to clause 11 or 12, wherein the operation is disabled for a predetermined period of time.
   14. An aerosol provision system according to any preceding clause, wherein the output signal comprises at least one of: an optical signal, an acoustic signal, and a haptic signal.
   15. An aerosol provision system according to any preceding clause, further comprising a cartridge and a control unit,
wherein the reservoir, the wick, and the vaporizer are located in the cartridge,
wherein the control unit comprises a cartridge receiving section that includes an interface arranged to cooperatively engage with the cartridge so as to releasably couple the cartridge to the control unit, wherein the control unit further comprises a power supply and the control circuitry.
   16 An aerosol provision system according to clause 15, when further dependent on clause 3 or 4, wherein the first temperature sensor is located in the cartridge, and is configured to be powered by the power supply from the control unit.
   17. An aerosol provision system according to clause 15 or 16, when further dependent on any of clauses 5-7, wherein the second temperature sensor is located in the cartridge, and is configured to be powered by the power supply from the control unit.
   18. An aerosol provision system according to any preceding clause, wherein the vaporizer is coiled around the wick.
   19. An aerosol provision system according to any preceding clause, wherein the wick comprises a ceramic wick.
   20. A method of monitoring temperatures in an aerosol provision system comprising a reservoir for aerosolizable material, a wick configured to receive the aerosolizable material from the reservoir, and a vaporizer for vaporising aerosolizable material in the wick, wherein the method comprises control circuitry from the aerosol provision system:
determining a first parameter relating to a temperature of the vaporizer;
determining a second parameter relating to a temperature of the wick;
performing a comparison between the first parameter and the second parameter; and
generating an output signal based on the comparison.
   21. The method according to clause 20, wherein the method further comprises the control circuitry:
measuring the resistance of the vaporizer;
generating first data related to the resistance of the vaporizer; and
processing the first data to determine the first parameter;
   wherein the method further comprises:
outputting, from a temperature sensor, a signal containing second data related to the temperature of the wick;
receiving, at the control circuitry, the signal from the temperature sensor; and
processing, at the control circuitry, the second data from the signal to determine the second parameter.
   22. The method according to clause 20 or 21, wherein the steps of performing a comparison between the first parameter and the second parameter, and generating an output signal based on the comparison, further comprises the control circuitry:
dividing one of the first and second parameters by the other of the first and second parameters to determine a ratio, and generating the output signal in the event the ratio falls outside a predetermined range.
   23. The method according to any of clauses 20-22, wherein the output signal comprises a command to disable the operation of the aerosol provision system or the operation of the vaporizer.

### Third Set of Clauses

1. An aerosol provision system comprising:
a heating element for generating a vapour from an aerosolizable material; and
control circuitry configured to provide power for the heating element for performing a heating operation to generate the vapour, and configured for use in detecting a fault condition, wherein the control circuitry is configured to:
establish a first resistance value for the resistance of the heating element at a first predetermined time during the heating operation; and
establish a second resistance value for the heating element at a second predetermined time, after the first predetermined time, during the heating operation;
compare the second resistance value with an expected resistance value, wherein the expected resistance value is higher than, and based on, the first resistance value; and
detect a fault condition in the event the second resistance value exceeds the expected resistance value by a predetermined amount, wherein the predetermined amount decreases as the first resistance value increases.
   2. An aerosol provision system according to clause 1, wherein the second predetermined time immediately follows a first predetermined time interval starting from the first predetermined period of time.
   3. An aerosol provision system comprising:
a heating element for generating a vapour from an aerosolizable material; and
control circuitry configured to provide power for the heating element for performing a heating operation to generate the vapour, and configured for use in detecting a fault condition, wherein the control circuitry is configured to:
establish a first resistance value for the resistance of the heating element at a first predetermined time during the heating operation;
establish the time taken, from the first predetermined time, for the heating element to reach a predetermined resistance value during the heating operation, wherein the predetermined resistance value is larger than the first resistance value;
compare the time taken with an expected time taken, wherein the expected time taken is based on the first resistance value; and
detect a fault condition in the event the time taken is less than the expected time taken by at least a predetermined amount, wherein the predetermined amount decreases as the first resistance value increases.
   4. An aerosol provision system according to any preceding clause, wherein the first predetermined time is at the beginning of the heating operation.
   5. An aerosol provision system according to any preceding clause, wherein the first predetermined time is the time when power is first provided to the heating element for the heating operation.
   6. An aerosol provision system according to any of clauses 1-4, wherein the first predetermined time immediately follows an initial predetermined time interval starting from when power is first provided to the heating element for the heating operation.
   7. An aerosol provision system according to any preceding clause, wherein the control circuitry is configured to monitor the resistance of the heating element to determine the first resistance value.
   8. An aerosol provision system according to any preceding clause, wherein the aerosol provision system further comprises a sensor, wherein the sensor is configured to output a sensor signal containing data related to the temperature of the heating element;
wherein the control circuitry is configured to receive the sensor signal to establish the first resistance value from the data from the sensor signal.
   9. An aerosol provision system according to any preceding clause, wherein response to detecting the fault condition, the control circuitry is further configured to:
disable the operation of the aerosol provision system.
   10. An aerosol provision system according to any preceding clause, wherein response to detecting the fault condition, the control circuitry is further configured to:
disable the operation of the heating element.
   11. An aerosol provision system according to any preceding clause, wherein response to detecting the fault condition, the control circuitry is further configured to:
generate an output signal for providing a notification to a user.
   12. An aerosol provision system according to clause 11, wherein the output signal is at least one of: an optical signal, an acoustic signal, and a haptic signal.
   13. The aerosol provision system of any preceding clause, further comprising a reservoir for holding the aerosolizable material.
   14. An aerosol provision system according to clause 13, further comprising a cartridge and a control unit,
wherein the reservoir and the heating element are located in the cartridge,
wherein the control unit comprises a cartridge receiving section that includes an interface arranged to cooperatively engage with the cartridge so as to releasably couple the cartridge to the control unit, wherein the control unit further comprises a power supply and the control circuitry.
   15. The aerosol provision system according to clause 13 or 14, wherein the aerosol provision system further comprises a wick configured to receive the aerosolizable material from the reservoir, wherein the heating element is configured to vaporize the aerosolizable material received in the wick.
   16. A method of detecting a fault condition in an aerosol provision system, wherein the aerosol provision system further comprises control circuitry, and wherein the method comprises the control circuitry:
providing power to a heating element for performing a heating operation to generate vapour from an aerosolizable material;
establishing a first resistance value for the resistance of the heating element at a first predetermined time during the heating operation;
establishing a second resistance value for the heating element at a second predetermined time, after the first predetermined time, during the heating operation;
comparing the second resistance value with an expected resistance value, wherein the expected resistance value is higher than, and based on, the first resistance value; and
detecting a fault condition in the event the second resistance value exceeds the expected resistance value by a predetermined amount, wherein the predetermined amount decreases as the first resistance value increases.
   17. A method of detecting a fault condition in an aerosol provision system, wherein the aerosol provision system further comprises control circuitry, and wherein the method comprises the control circuitry:
providing power to a heating element for performing a heating operation to generate vapour from an aerosolizable material;
establishing a first resistance value for the resistance of the heating element at a first predetermined time during the heating operation; and
establishing the time taken, from the first predetermined time, for the heating element to reach a predetermined resistance value during the heating operation, wherein the predetermined resistance value is larger than the first resistance value;
comparing the time taken with an expected time taken, wherein the expected time taken is based on the first resistance value; and
detecting a fault condition in the event the time taken is less than the expected time taken by at least a predetermined amount, wherein the predetermined amount decreases as the first resistance value increases.

1. An aerosol provision system comprising:
a reservoir for aerosolisable material;
a vaporizer for vaporizing aerosolizable material from the reservoir;
a sensor system, separate from the vaporizer, for detecting the temperature of the vaporizer, wherein the sensor system comprises a first resistor.

2. The aerosol provision system of claim 1, wherein the sensor system is configured to measure a voltage drop across the first resistor.

3. The aerosol provision system of claim 2, wherein the sensor system is configured to determine the temperature of the vaporizer based on the voltage drop across the first resistor.

4. The aerosol provision system of claim 1, wherein the first resistor is located proximate to the vaporizer.

5. The aerosol provision system of claim 1, wherein the sensor system further comprises a second resistor.

6. The aerosol provision system of claim 5, wherein the second resistor is connected in series with the first resistor.

7. The aerosol provision system of claim 5, wherein the sensor system is further configured to measure a voltage drop across the second resistor.

8. The aerosol provision system of claim 5, wherein the second resistor is located proximate to the vaporizer.

9. The aerosol provision system of claim 8, wherein the first resistor is located closer to the vaporizer than the second resistor is located to the vaporizer.

10. The aerosol provision system of claim 7, when further dependent on claim 3, wherein the sensor system is configured to determine the temperature of the vaporizer based on the measured voltage drop across the first resistor in combination with the measured voltage drop across the second resistor.

11. The aerosol provision system of claim 1, further comprising a first power supply configured to provide electrical power to the vaporizer.

12-13. (canceled)

14. The aerosol provision system of claim 11, further comprising control circuitry configured to adjust the amount of power provided by the first power supply to the vaporizer.

15. The aerosol provision system of claim 14, wherein the control circuitry comprises a portion of the sensor system.

16. The aerosol provision system of claim 14, wherein the sensor system is configured to provide an output signal containing data related to the temperature of the vaporizer, wherein the control circuitry is configured to:
process the data from the output signal; and
generate, in response to processing the data from the output signal, a first control signal for controlling the operation of the first power supply.

17. The aerosol provision system of claim 16, wherein the first control signal comprises a command to vary the amount of power provided by the first power supply to the vaporizer.

18. The aerosol provision system of claim 16, wherein the first control signal comprises a command to stop providing power to the vaporizer from the first power supply.

19. The aerosol provision system of claim 11, further comprising a second power supply for providing electrical power to the sensor system.

20. The aerosol provision system of claim 19, wherein the second power supply is independent of the first power supply.

21-22. (canceled)

23. The aerosol provision system of of claims 19-22, when further dependent on claim 18, further comprising a second power supply for providing electrical power to the sensor system, and wherein the control circuitry is further configured to:
generate, in response to processing the data from the output signal, a second control signal for controlling the operation of the second power supply, wherein the second control signal comprises a command to stop providing power to the sensor system from the second power supply.

24. The aerosol provision system of claim 1, further comprising a wick configured to receive the aerosolisable material from the reservoir, wherein the vaporizer is configured to vaporize the aerosolizable material received in the wick.

25-26. (canceled)

27. The aerosol provision system of claim 24, wherein each resistor from the sensor system is located on an external surface of the wick.

28. (canceled)

29. The aerosol provision system of claim 1, further comprising a cartridge and a control unit;
wherein the reservoir, the vaporizer, and the first resistor, are located in the cartridge;
wherein the control unit comprises a cartridge receiving section that includes an interface arranged to cooperatively engage with the cartridge so as to releasably couple the cartridge to the control unit.

30. The aerosol provision system of claim 29, further comprising a first power supply configured to provide electrical power to the vaporizer, and wherein the control unit comprises the first power supply.

31. The aerosol provision system of claim 30, further comprising a second power supply for providing electrical power to the sensor system and wherein the control unit comprises the second power supply.

32. (canceled)

33. A cartridge for an aerosol provision system comprising the cartridge and a control unit, wherein the cartridge comprises:
a reservoir for aerosolisable material;
a vaporizer for vaporizing aerosolizable material from the reservoir; and
a sensor system, separate from the vaporizer, for detecting the temperature of the vaporizer, wherein the sensor system comprises a first resistor.

34-100. (canceled)
